(19) United States
(12) Patent Application Publication
(10) Pub. No.: US 2016/0216815 A1
(43) Pub. Date: Jul. 28, 2016

(54) TOUCH DISPLAY

(71) Applicant: Innolux Corporation, Chu-Nan (TW)

(72) Inventor: Kazuyuki HASHIMOTO, Chu-Nan (TW)

(73) Assignee: Innolux Corporation, Chu-Nan (TW)

(21) Appl. No.: 14/608,184

(22) Filed: Jan. 28, 2015

(51) Int. Cl. G06F 3/041; G09G 5/02

(52) U.S. Cl. CPC G06F 3/0412; G09G 5/02; G06F 2203/04112; G09G 2320/0242; G09G 2300/0452

(57) ABSTRACT

A touch display is provided, comprising a display device comprising a plurality of sub-pixels, and a touch layer at least comprising a sensing unit and coupled to the display device. The sub-pixels at least comprise first colored sub-pixels, second colored sub-pixels and third colored sub-pixels. The sensing unit exposes at least one boundary adjacent to one side of each of the sub-pixels. The sensing unit comprises a plurality of sets of line segments, and each set of line segments at least comprises three line segments disposed correspondingly to predetermined boundaries of the sub-pixels. A total number of the first colored sub-pixels adjacent to same sides of the predetermined boundaries, a total number of the second colored sub-pixels adjacent to same sides of the predetermined boundaries, and a total number of the third colored sub-pixels adjacent to same sides of the predetermined boundaries are identical.

### BACKGROUND

1. Field of the Invention

The disclosure relates in general to a touch display, more particularly to the touch display with color moiré free design.

2. Description of the Related Art

An electronic product with a display includes a smart phone, a tablet computer (Pad), a notebook computer (Notebook), a monitor or even the television (TV)-associated products, and has become an indispensable necessity of the modern human beings in either the working-processing-learning or the personal leisure entertainment.

Touch displays are extensively applied to the electronic products to facilitate interactions between users and the electronic products. In a typical touch display, a touch layer having the sensing unit (such as sensing electrode) is coupled to a display device (ex: by setting on the top surface of the display device) to allow a user to enter a response by touching an inquiry message displayed on the display apparatus, make a selection by touching an option of a menu displayed on the display apparatus, scroll a menu list, or even provide an entry in a desired format such as drawing an object on the display apparatus or entering texts by handwriting characters. In addition to seeking for the more excellent electronic property of the electronic product itself, such as the higher quality display effect, the higher response speed upon operation, the longer useful life and the higher stability, the consumer further expects more diversified functions. It is, of course, that one of the most important features that consumers expect of the electronic products is display quality; for example, color moiré of the touch display is the unacceptable defect for the consumers.

FIG. 1A illustrates a cross-sectional view of the first type of the conventional touch displays. FIG. 2A illustrates a cross-sectional view of the second type of the conventional touch displays. Please refer to FIG. 1A and FIG. 2A. As shown in FIG. 1A and FIG. 2A, a touch display 1 comprises a display device 11 and a touch layer TP-1 (or TP-2) disposed on and coupled to the display device 11. The display device 11 includes a first substrate 111, a second substrate 113, a liquid crystal layer 115 disposed between the first substrate 111 and the second substrate 113, and a backlight unit 117 as a light source. The first substrate 111 such as a TFT substrate comprises components such as a first transparent conductive layer (ex: ITO layer) patterned to create the pixel electrodes, the patterned conductive traces, and the thin film transistors (TFTs) (not shown in FIG. 1A) formed on a first transparent base (i.e. a TFT glass). The second substrate 113 such as a CF substrate comprises components such as a second transparent conductive layer (ex: ITO layer), a light-shielding patterned layer such as the black matrix BM, and a color filter photoresist layer formed on a second transparent base (i.e. a CF glass). As shown in FIG. 1A and FIG. 2A, the touch layer TP-1 (or TP-2) comprises a metal mesh M1 (or M2) as a sensing unit, and the metal mesh M1 can be formed on the CF glass of the second substrate 113 (“MOG”).

Differences between the metal mesh M1 of FIG. 1A and the metal mesh M2 of FIG. 2A are positions of metal line segments aligned with the sub-pixels or pixels of the display device 11. As shown in FIG. 1A, the metal mesh M1 is formed with metal line segments aligned with every row and column boundaries of the sub-pixels of the display device 11. As shown in FIG. 2A, the metal mesh M2 is formed with metal line segments aligned with the row and column boundaries of the pixels of the display device 11. The boundaries of the sub-pixels and pixels are inefficient areas for the optical performance, and the black matrix (BM) is formed to prevent color mix and light leak in some displays such as IPS. For the touch display (such as the IPS-type display incorporated with metal mesh), the metal mesh M1 (or M2) is aligned with the position of the BM (i.e. “hidden” behind the BM).

If the metal mesh in every sub-pixel boundary blocks light from R/G/B sub-pixel equally, no color unbalance (Color Moiré) issue needs to be concerned. However luminance drop would be significant when it is cooperated with high-ppi display device. FIG. 1B-1 to FIG. 1B-5 depict the relationships between the metal mesh and the sub-pixels of the touch display of FIG. 1A at different horizontal viewing angles. Please also refer to FIG. 1C and FIG. 1D, which illustrate the horizontal viewing angles θ_{H} along the ZX-plane and vertical viewing angles θ_{V} along the YZ-plane, respectively. A touch display hangs up on the XY-plane. FIG. 1C also denotes a horizontal on axis A_{H0} and the horizontal off axes A_{H1}, A_{H2}, A_{H3} and A_{H4}, and FIG. 1D also denotes a vertical on axis A_{V0} and the vertical off axes A_{V1}, Aᵥ₂, Aᵥ₃ and A_{V4}. As shown in FIG. 1B-1, when the touch display of FIG. 1 is viewed from the horizontal on axis A_{H0}, images with correct colors and no loss of luminance are perceived by the viewer. In FIG. 1B-2 and FIG. 1B-3, which show that the touch display of FIG. 1A is viewed from the horizontal off axis A_{H1} and A_{H2} (ex: the left area of the touch display). Although correct color images with no loss of luminance as shown in FIG. 1B-3 are perceived by the viewer, the images with balanced color but luminance drop as shown in FIG. 1B-2 are perceived by the viewer. In FIG. 1B-4 and FIG. 1B-5, which show that the touch display of FIG. 1A is viewed from the horizontal off axis A_{H3} and A_{H4} (ex: the right area of the touch display). Similarly, although correct color images with no loss of luminance as shown in FIG. 1B-5 are perceived by the viewer, the images with balanced color but luminance drop as shown in FIG. 1B-4 are perceived by the viewer. The higher the pixel density (i.e. higher ppi) of the touch display of FIG. 1A, the more significant of the luminance drop to the touch display.

If the metal mesh in every pixel boundary is constructed in the touch display as shown in FIG. 2A, the touch display has an advantage of luminance against the “sub-pixel metal mesh” type of the display of FIG. 1A, but it has a risk of color unbalance (“Color Moiré”) from view of off-axis, which is caused by interference of the metal mesh M2 and the BM (metal mesh works as a kind of parallax barrier). FIG. 2B-1 to FIG. 2B-5 depict the relationships between the metal mesh and the pixels of the touch display of FIG. 2A at different horizontal viewing angles. As shown in FIG. 2B-1, when the touch display of FIG. 2A is viewed from the horizontal on axis A_{H0}, images with correct colors and no loss of luminance are perceived by the viewer. FIG. 2B-2 and FIG. 2B-3 show the touch display of FIG. 2A being viewed from the horizontal off axis A_{H1} and A_{H2} (ex: the left area of the touch display). As shown in FIG. 2B-3, the green sub-pixels are blocked by the metal mesh M2, and purplish (blue and red) color images will be perceived by the viewer. As shown in FIG. 2B-2, the blue sub-pixels are blocked by the metal mesh M2, and yellowish (green and red) color images will be perceived by the viewer. FIG. 2B-4 and FIG. 2B-5 show the touch display of FIG. 2A being viewed from the horizontal off axis A_{H3} and A_{H4} (ex: the right area of the touch display). As shown in FIG. 2B-4, the red sub-pixels are blocked by the metal mesh M2, and cyanish (blue and green) color images will be perceived by the viewer. As shown in FIG. 2B-5, the green sub-pixels are blocked by the metal mesh M2, and purplish (blue and red) color images will be perceived by the viewer.

Thus, it is desirable to construct a metal mesh design, which gives the consideration of the improvement of luminance loss and the prevention of color moiré, especially for the metal mesh design suitable for the application in the high-resolution (high-ppi) touch displays.

### SUMMARY

The disclosure relates to a touch display, more particularly to the touch display with color moiré free design. According to the embodiments, the color unbalance can be greatly improved even successfully avoided when the viewer watches the display from different viewing angles, such as from the left and right areas of the display from the viewing angles along the horizontal off axes, or from the upper and lower areas of the display from the viewing angles along the vertical off axes. Thus, no color moiré can be perceived in viewing the images displayed on the touch display of the embodiments of the disclosure.

According to the present disclosure, a touch display is provided, comprising a display device comprising a plurality of sub-pixels, and a touch layer at least comprising a sensing unit and coupled to (located on) the display device. The sub-pixels at least comprise first colored sub-pixels, second colored sub-pixels and third colored sub-pixels. The sensing unit comprises a plurality of sets of line segments, and each set of line segments at least comprises three line segments disposed correspondingly to predetermined boundaries of the sub-pixels. A total number of the first colored sub-pixels adjacent to same sides of the predetermined boundaries, a total number of the second colored sub-pixels adjacent to same sides of the predetermined boundaries, and a total number of the third colored sub-pixels adjacent to same sides of the predetermined boundaries are identical. Accordingly, the color unbalance issue can be solved.

The disclosure will become apparent from the following detailed description of the preferred but non-limiting embodiments. The following description is made with reference to the accompanying drawings.

### BRIEF DESCRIPTION OF THE DRAWINGS

FIG. 1A (Prior Art) illustrates a cross-sectional view of the first type of the conventional touch displays.

FIG. 1B-1 (Prior Art) to FIG. 1B-5 (Prior Art) depict the relationships between the metal mesh and the sub-pixels of the touch display of FIG. 1A at different horizontal viewing angles.

FIG. 1C and FIG. 1D illustrate the horizontal viewing angles θ_{H} along the ZX-plane and vertical viewing angles θ_{V} along the YZ-plane, respectively.

FIG. 2A (Prior Art) illustrates a cross-sectional view of the second type of the conventional touch displays.

FIG. 2B-1 (Prior Art) to FIG. 2B-5 (Prior Art) depict the relationships between the metal mesh and the pixels of the touch display of FIG. 2A at different horizontal viewing angles.

FIG. 3A illustrates one set of line segments of a touch layer disposed correspondingly to the predetermined boundaries of the sub-pixels of a display device of a touch display according to the first embodiment of the disclosure.

FIG. 3B-1, FIG. 3B-2 and FIG. 3B-3 depict the configurations between the line segments and the sub-pixels of FIG. 3A at different horizontal viewing angles according to the first embodiment of the disclosure.

FIG. 4A illustrates several sets of line segments of a touch layer disposed correspondingly to the predetermined boundaries of the sub-pixels of a display device of a touch display according to the Embodiment 1-1 of the disclosure.

FIG. 4B-1 and FIG. 4B-2 depict the configurations between the line segments and the sub-pixels of FIG. 4A at different horizontal viewing angles according to the Embodiment 1-1 of the disclosure.

FIG. 5A illustrates several sets of line segments of a touch layer disposed correspondingly to the predetermined boundaries of the sub-pixels of a display device of a touch display according to the Embodiment 1-2 of the disclosure.

FIG. 5B-1 and FIG. 5B-2 depict the configurations between the line segments and the sub-pixels of FIG. 4A at different horizontal viewing angles according to the Embodiment 1-2 of the disclosure.

FIG. 6A illustrates several sets of line segments of a touch layer disposed correspondingly to the predetermined boundaries of the sub-pixels of a display device of a touch display according to the Embodiment 1-3 of the disclosure.

FIG. 6B-1 and FIG. 6B-2 depict the configurations between the line segments and the sub-pixels of FIG. 6A at different horizontal viewing angles according to the Embodiment 1-3 of the disclosure.

FIG. 7A and FIG. 7B illustrate several sets of line segments of two types of the touch layers disposed correspondingly to the predetermined boundaries of the sub-pixels of the display devices of the touch displays according to the Embodiment 1-4 of the disclosure.

FIG. 8A illustrates one set of line segments of a touch layer disposed correspondingly to the predetermined boundaries of the sub-pixels of a display device of a touch display according to the second embodiment of the disclosure.

FIG. 8B-1, FIG. 8B-2 and FIG. 8B-3 depict the configurations between the line segments and the sub-pixels of FIG. 8A at different vertical viewing angles according to the second embodiment of the disclosure.

FIG. 9A illustrates several sets of line segments of a touch layer disposed correspondingly to the predetermined boundaries of the sub-pixels of a display device of a touch display according to the Embodiment 2-1 of the disclosure.

FIG. 9B-1, FIG. 9B-2 and FIG. 9B-3 depict the configurations between the line segments and the sub-pixels of FIG. 9A at different vertical viewing angles according to the Embodiment 2-1 of the disclosure.

FIG. 10A illustrates several sets of line segments of a touch layer disposed correspondingly to the predetermined boundaries of the sub-pixels of a display device of a touch display according to the Embodiment 2-2 of the disclosure.

FIG. 10B-1, FIG. 10B-2 and FIG. 10B-3 depict the configurations between the line segments and the sub-pixels of FIG. 10A at different vertical viewing angles according to the Embodiment 2-2 of the disclosure.

FIG. 11, FIG. 12 and FIG. 13 illustrate several sets of line segments of a touch layer disposed correspondingly to the predetermined boundaries of the sub-pixels of a display device of a touch display according to the Embodiments 3-1, 3-2 and 3-3 of the disclosure, respectively.

FIG. 14, FIG. 15 and FIG. 16 illustrate several sets of line segments of a touch layer disposed correspondingly to the predetermined boundaries of the sub-pixels of a display device of a touch display according to the Embodiments 4-1, 4-2 and 4-3 of the disclosure, respectively.

### DETAILED DESCRIPTION

The embodiments of the present disclosure disclosed below are for elaborating a touch display, in particular, a touch display with color moiré free design. According to the embodiments, a touch layer comprising a sensing unit such as a metal mesh sensor is cooperated with a display device of a touch layer, and a sensing unit (ex: metal mesh) design with minimum influence on the optical performance is provided. Also, the touch layer with the sensing unit of the embodiment is capable of suppressing color moiré caused by the interference between the opaque sensing unit (ex: metal mesh) and pixels of the display device.

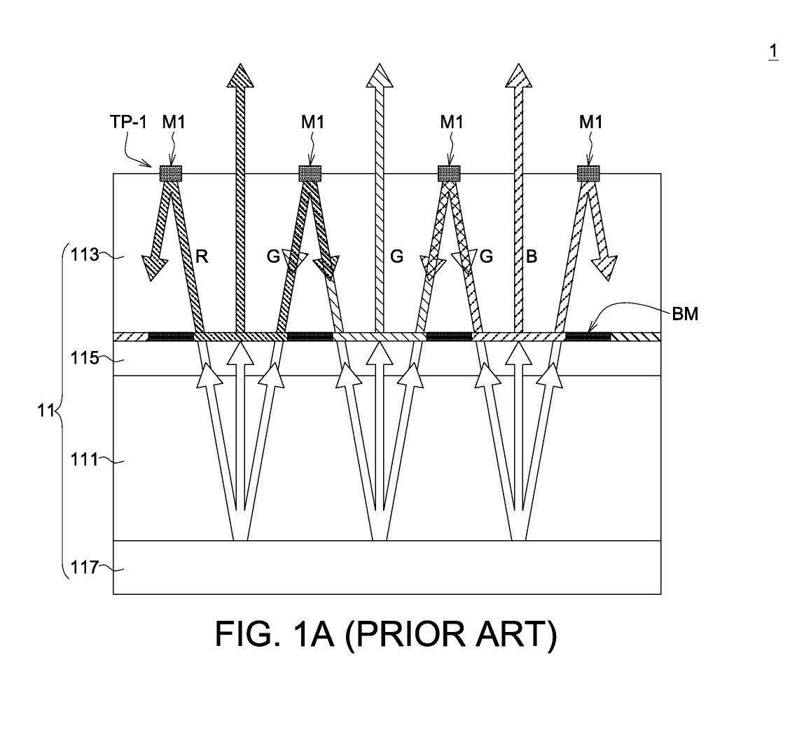

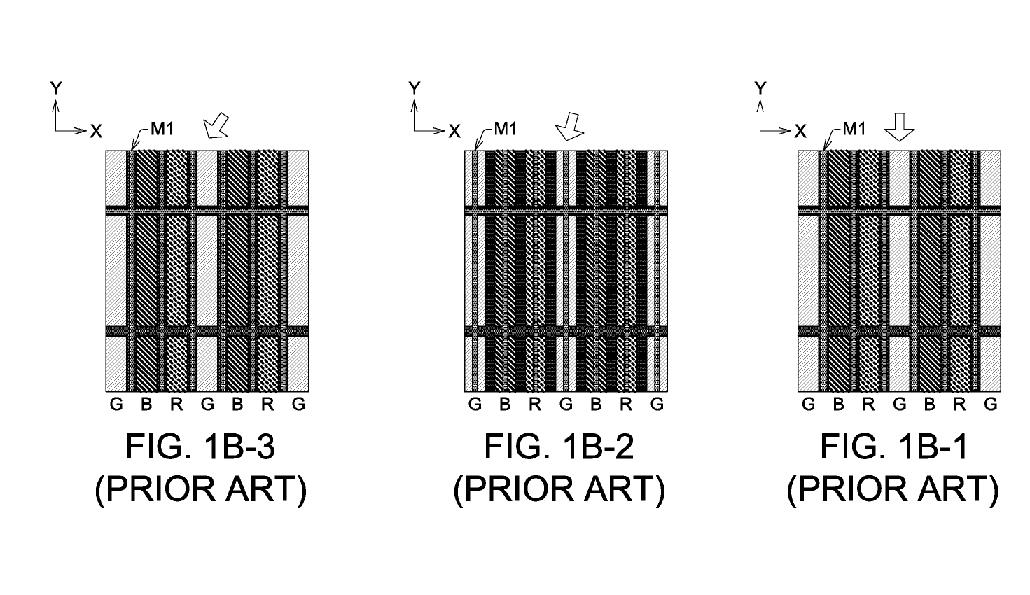

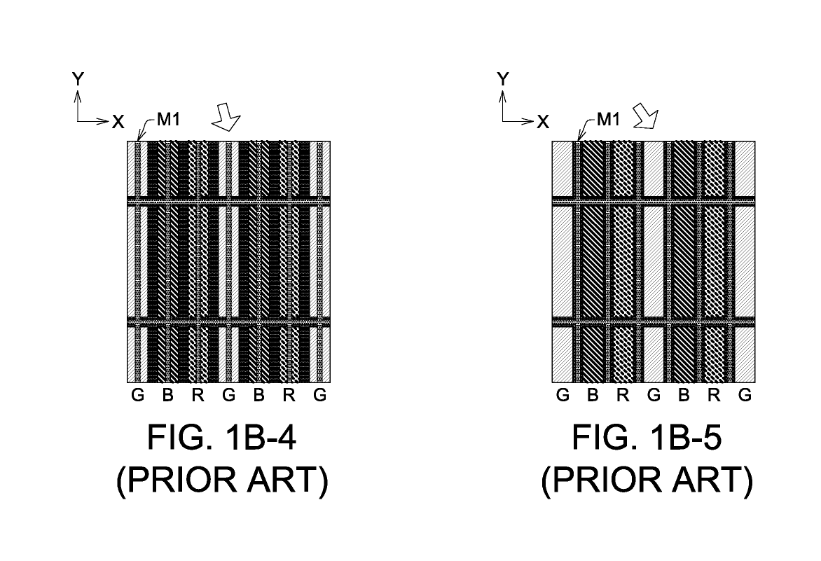

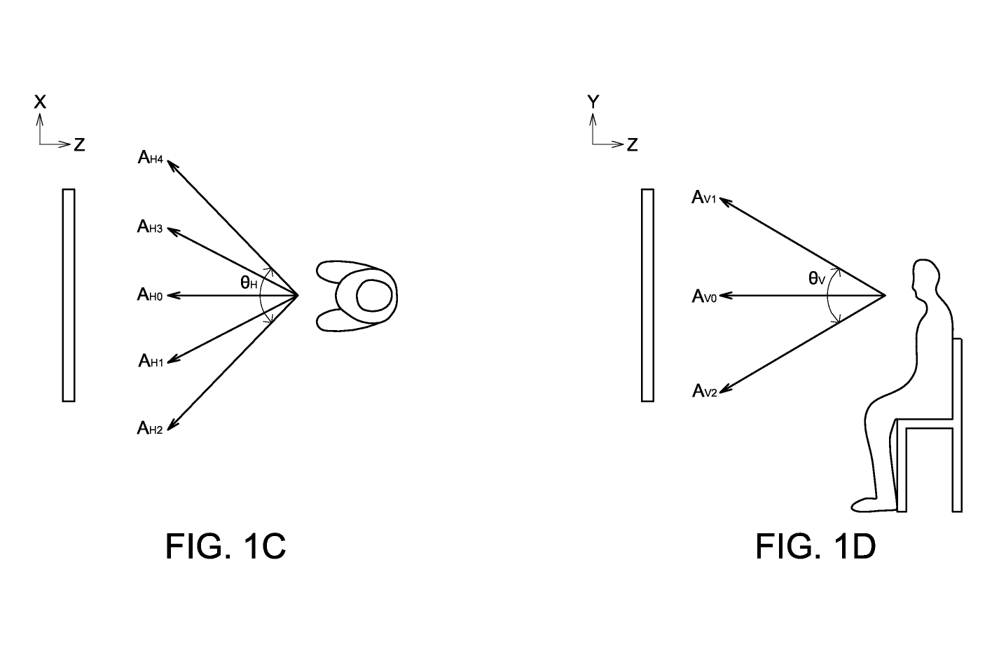

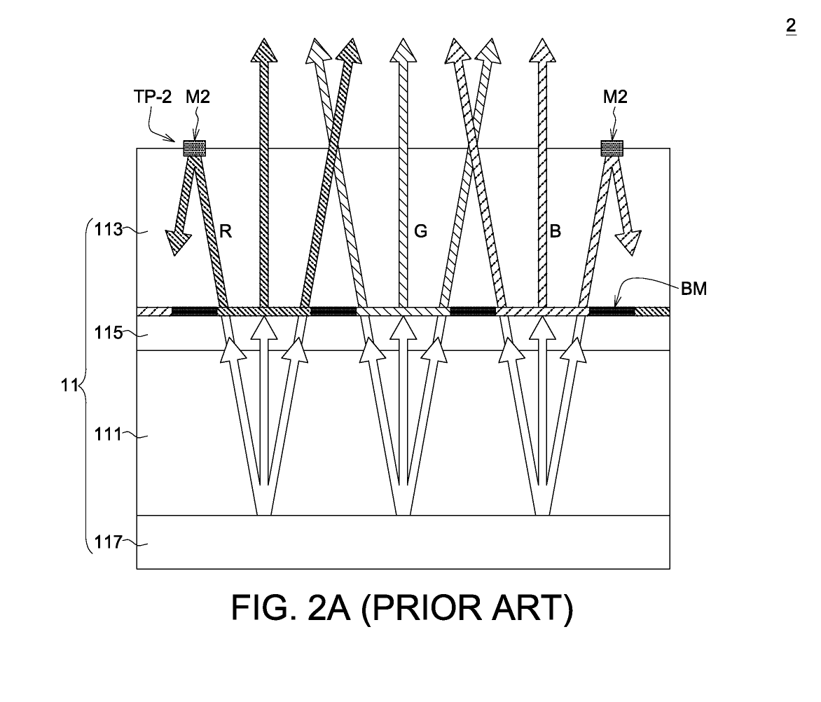

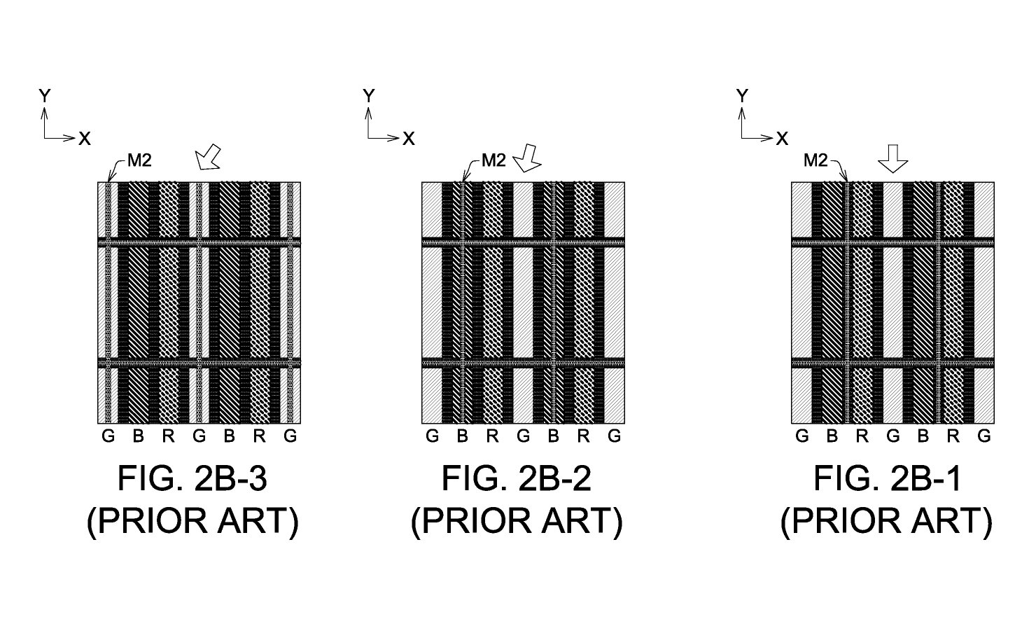

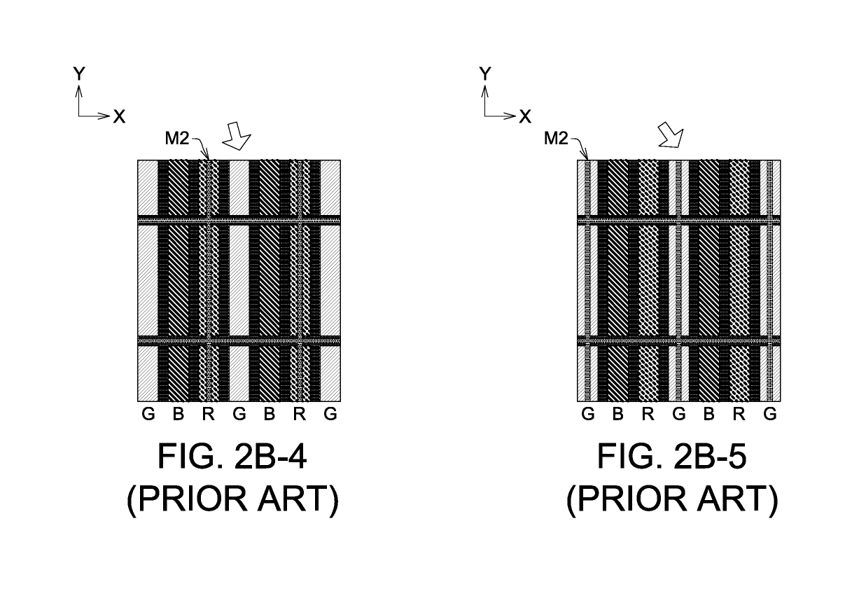

The embodiments of the present disclosure can be applied to many different types of touch layers. A basic configuration of a touch layer as depicted in FIG. 1A and FIG. 2A is illustrated for exemplifying some related components of the embodiments, such as the display device 11 (including the first substrate 111, the second substrate 113, the liquid crystal layer 115 and the backlight unit 117) and a touch layer TP-1/TP-2. Please refer to the description above, and the details are not redundantly repeated hereinafter. However, the disclosure is not limited to the types of the touch layers applied with the embodied design(s).

According to the embodiments, a touch display comprising a display device and a touch layer coupled to (ex: located on) the display device is provided, wherein the display device comprises a plurality of sub-pixels, and the touch layer at least comprises a sensing unit. The sub-pixels at least comprise a plural of first colored sub-pixels, second colored sub-pixels and third colored sub-pixels. The sensing unit comprises a plurality of sets of line segments, such as column line segments or row line segments. In one embodiment, the sensing unit is a mesh having conducting lines woven together and coupled to each other (ex: metal mesh), wherein the conductor lines comprises the column or row line segments. Each set of line segments at least comprises three line segments (ex: three or four line segments) disposed correspondingly to predetermined boundaries of the sub-pixel, wherein the numbers of the different colored sub-pixels adjacent to same sides of the predetermined boundaries of the sub-pixels are identical. Noted the term of the “predetermined boundary (or “predetermined boundaries”) herein is referred to the boundary (or boundaries) of the sub-pixel(s) corresponding to the line segment(s). Therefore, when the touch display of the embodiment is viewed from the horizontal off-axis or the vertical off-axis, these line segments (ex: three or four line segments) cover each of the color pigments (such as colored sub-pixels R, G and B) equally. In other words, the covering parts of the different colored sub-pixels are compensated each other to achieve the color balance. Thus, no color moiré is perceived for viewing the images displayed on the touch displays of the embodiments. Also, in any of the following embodiments, the sensing unit (such as metal mesh) of the touch layer as provided exposes (uncovers) at least one boundary adjacent to one side of each sub-pixel (i.e. not all of the boundaries of each sub-pixel correspondingly being enclosed by the sensing unit).

As shown in FIG. 1A, the metal mesh M1 is formed with metal line segments aligned with every row and column boundaries of the sub-pixels of the display device 11. As shown in FIG. 2A, the metal mesh M2 is formed with metal line segments aligned with the row and column boundaries of the pixels of the display device 11.

Several embodiments are provided hereinafter with reference to the accompanying drawings for describing the related configurations, such as the sensing unit (such as metal mesh) design of the touch layer and the sub-pixels of the display device of the touch display. However, the present disclosure is not limited thereto. The identical and/or similar elements of the embodiments are designated with the same and/or similar reference numerals. Also, it is noted that there may be other embodiments of the present disclosure which are not specifically illustrated. It is also important to point out that the illustrations may not be necessarily be drawn to scale. Thus, the specification and the drawings are to be regard as an illustrative sense rather than a restrictive sense.

### First Embodiment

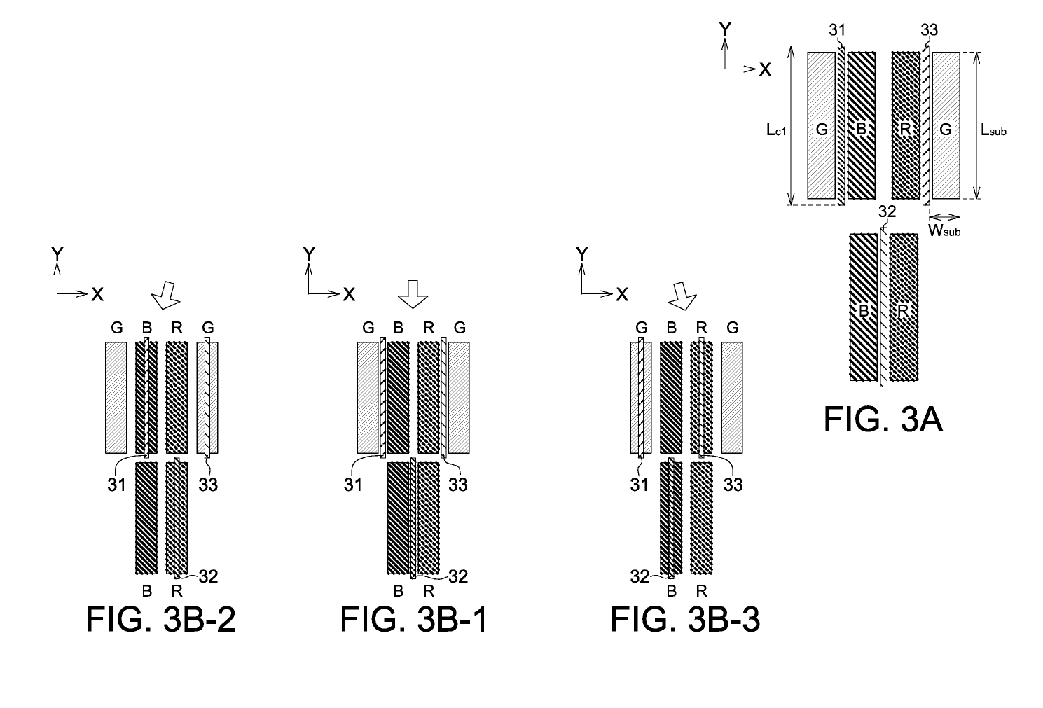

FIG. 3A illustrates one set of line segments of a touch layer disposed correspondingly to the predetermined boundaries of the sub-pixels of a display device of a touch display according to the first embodiment of the disclosure. FIG. 3B-1, FIG. 3B-2 and FIG. 3B-3 depict the configurations between the line segments and the sub-pixels of FIG. 3A at different horizontal viewing angles according to the first embodiment of the disclosure.

In the first embodiment, one set of line segments of the sensing unit (ex: a metal mesh) comprises three column line segments, such as a first column line segment 31, a second column line segment 32 and a third column line segment 33 disposed correspondingly to the predetermined boundaries of the sub-pixels, as shown in FIG. 3A. In the first and second embodiments, the sub-pixels comprising three different colors is illustrated for exemplification, including a first colored sub-pixels (such as Red sub-pixels, “R” in the figures), a second colored sub-pixels (such as Green sub-pixels, “G” in the figures) and a third colored sub-pixels (such as Blue sub-pixels, “B” in the figures).

Also, the sets of line segments of the first embodiment are column line segments parallel to a column direction (i.e. the columns of sub-pixels arranged along the Y-direction) of the sub-pixels, and the first sides and the second sides of the predetermined boundaries of the sub-pixels are left sides and right sides of the boundaries corresponding to the set of column line segments, respectively.

According to the first embodiment, positions of the three column line segments of each set are arranged to compensate color unbalance each other when the touch display is viewed from the horizontal off axis. As shown in FIG. 3A, a Green sub-pixel is adjacent to the left side of the first column line segment 31, and a Blue sub-pixel is adjacent to the right side of the first column line segment 31. A Blue sub-pixel is adjacent to the left side of the second column line segment 32, and a Red sub-pixel is adjacent to the right side of the second column line segment 32. A Red sub-pixel is adjacent to the left side of third column line segment 33, and a Green sub-pixel is adjacent to the right side of third column line segment 33. Accordingly, a total number (referred to “N1-1”) of the first colored (Red) sub-pixels adjacent to same sides (such as the first sides, ex: the right sides) of the predetermined boundaries (of the sub-pixels corresponding to the three column line segments (31-33) of each set), a total number (referred to “N2-1”) of the second colored (Green) sub-pixels adjacent to same sides of the predetermined boundaries, and a total number (referred to “N3-1”) of the third colored (Blue) sub-pixels adjacent to same sides of the predetermined boundaries are identical according to the embodiments of the disclosure. In FIG. 3A, N1-1=N2-1=N3-1.1.

Furthermore, the predetermined boundaries of the sub-pixels have second sides (ex: the left sides) opposite to the first sides (ex: the right sides). According to the embodiments, a total number (“N1-2”) of the first (Red) colored sub-pixels adjacent to the second sides (ex: the left sides) of the predetermined boundaries of the sub-pixels corresponding to each set of line segments, a total number (“N2-2”) of the second (Green) colored sub-pixels adjacent to the second sides of the predetermined boundaries, and a total number (“N3-2”) of the third (Blue) colored sub-pixels adjacent to the second sides of the predetermined boundaries are identical. In FIG. 3A, N1-2=N2-2=N3-2=1.

Also, in one embodiment, N1-1 is equal to N1-2, N2-1 is equal to N2-2, and N3-1 is equal to N3-2, which means the numbers of the same colored sub-pixels respectively adjacent to two opposite sides of the predetermined boundaries of the sub-pixels corresponding to the three column line segments (31-33) of each set are identical. Also, a total number (i.e. “N1-1”+“N1-2”) of the first (Red) colored sub-pixels adjacent to two opposite sides of the predetermined boundaries, a total number (i.e. “N2-1”+“N2-2”) of the second (Green) colored sub-pixels adjacent to two opposite sides of the predetermined boundaries, and a total number (i.e. “N3-1”+“N3-2”) of the third (Blue) colored sub-pixels adjacent to two opposite sides of the predetermined boundaries are identical.

Please refer to FIG. 3A and FIG. 3B-1, to FIG. 3B-3. As shown in FIG. 3B-1, when the central area of the touch display is viewed from the horizontal on axes (ex: from the horizontal on axis A_{H0} of FIG. 1C), images with correct colors and no loss of luminance are perceived by the viewer. As shown in FIG. 3B-2, when the right area of the touch display is viewed from the horizontal off axes (ex: from the horizontal off axis A_{H3} of FIG. 1C), the three column line segments (i.e. first to third column line segments 31-33) of each set respectively cover one of each colored sub-pixels such as one Red sub-pixel, one Green sub-pixel and one Blue sub-pixel. As shown in FIG. 3B-3, when the left area of the touch display is viewed from the horizontal off axes (ex: from the horizontal off axis A_{H1} of FIG. 1C), the three column line segments (i.e. first to third column line segments 31-33) of each set also respectively cover one of each colored sub-pixels, such as one Red sub-pixel, one Green sub-pixel and one Blue sub-pixel. Therefore, the covering parts of the different colored sub-pixels are compensated each other to achieve the color balance. Accordingly, the color unbalance can be successfully avoided when the viewer watches the left and right areas of the touch display from viewing angles along the horizontal off axes. No color moiré would be perceived in viewing the images displayed on the touch displays of the embodiments.

In one embodiment, the length of the column line segments Lc1 (along the Y-direction) can be substantially equal to or slightly larger than a sub-pixel side length Lsub (i.e. the length of the long side of the sub-pixel), as shown in FIG. 3A. For example, Lc1 is larger than a sub-pixel side length and smaller than two times the sub-pixel side length (i.e. denoted as Lsub<Lc1<2×Lsub).

Embodiments 1-1, 1-2, 1-3 and 1-4 are provided below for elaborating some of possible designs of each set of the column line segments, based on the design concepts of the first embodiment.

### Embodiment 1-1

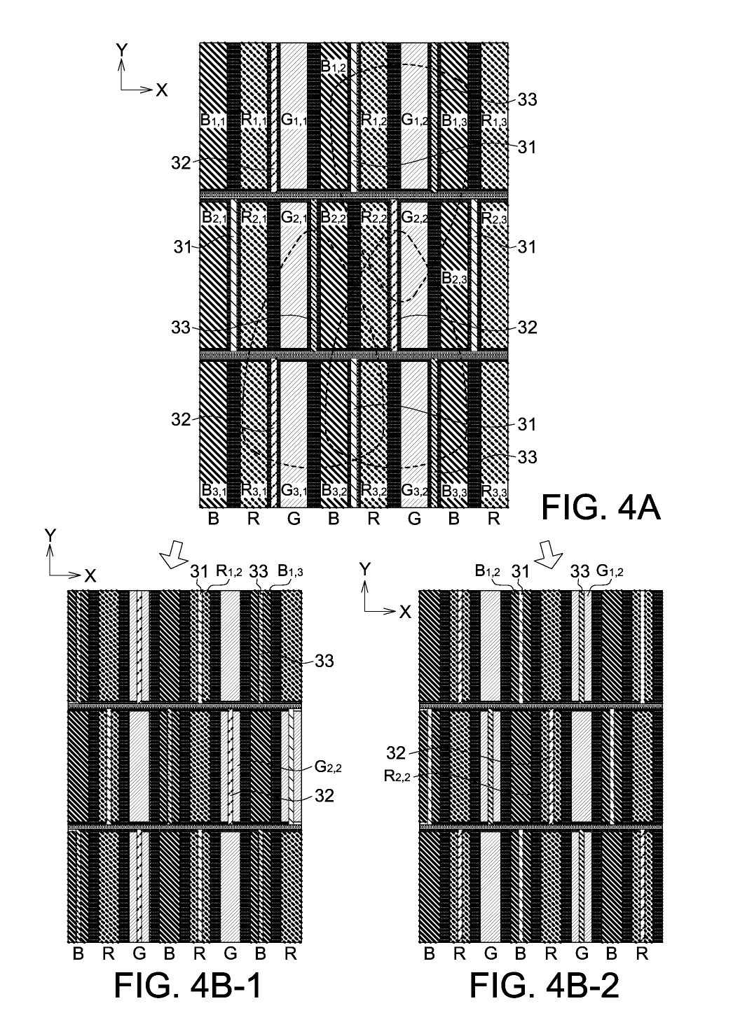

FIG. 4A illustrates several sets of line segments of a touch layer disposed correspondingly to the predetermined boundaries of the sub-pixels of a display device of a touch display according to the Embodiment 1-1 of the disclosure. FIG. 4B-1 and FIG. 4B-2 depict the configurations between the line segments and the sub-pixels of FIG. 4A at different horizontal viewing angles according to the Embodiment 1-1 of the disclosure.

In the Embodiment 1-1, as shown in FIG. 4A, each set of line segments comprises three column line segments, which includes the first column line segment 31, the second column line segment 32 and the third column line segment 33 disposed corresponding to the predetermined boundaries of the sub-pixels. Every combination of nearest 3 column line segments consisting of the first to three column line segments 31-33 is circled with the dash-lines in FIG. 4A for clear illustration.

In the Embodiment 1-1, the column line segments arranged correspondingly to the same row of the sub-pixels (such as 31, 32 and 33 corresponding to the first row) are spaced apart by a distance corresponding to two sub-pixels. Also, the column line segments arranged correspondingly to the same column of the sub-pixels (such as two column line segments 32 corresponding to the first R column) are spaced apart by a distance corresponding to one sub-pixel.

In the embodiment, the sub-pixels can be arranged as a matrix with m rows and n columns (i.e. m×n matrix or m-by-n matrix), m and n are integers larger than 1. As shown in FIG. 4A, the first (Red), second (Green) and third (Blue) colored sub-pixels are labeled as R_{1,1}, R_{1,2}, R_{1,3}, G_{1,1}, G_{1,2}, B_{1,1}, B_{1,2}, B_{1,3} (in the first row), R_{2,1}, R_{2,2}, R_{2,3}, G_{2,1}, G_{2,2}, B_{2,1}, B_{2,2}, B_{2,3} (in the second row), R_{3,1}, R_{3,2}, R_{3,3}, G_{3,1}, G_{3,2}, B_{3,1}, B_{3,2}, B_{3,3} (in the third row) etc. for illustration.

In the following embodiments (including illustrated configurations between the line segments and the sub-pixels of the first to fourth embodiments), it is noted that a total number of the first (ex: Red), second (ex: Green), third (ex: Blue) and fourth (ex: white) colored sub-pixels adjacent to the first sides (ex: the right sides for the embodiments with the column line segments, or the upper sides for the embodiments with the row line segments) of the predetermined boundaries of the sub-pixels corresponding to each set of line segments hereinafter are referred to “N1-1”, “N2-1”, “N3-1” and “N4-1” respectively. Similarly, a total number of the first (ex: Red), second (ex: Green), third (ex: Blue) and fourth (ex: white) colored sub-pixels adjacent to the second sides (ex: the left sides for the embodiments with the column line segments, or the lower sides for the embodiments with the row line segments) of the predetermined boundaries of the sub-pixels corresponding to each set of line segments are referred to “N1-2”, “N2-2”, “N3-2” and “N4-2”, respectively.

According to the Embodiment 1-1, N1-1 and N2-1 and N3-1 are identical, and N1-1=N2-1=N3-1=1. Take one set of line segments (including the first, second and third column line segments 31/32/33) for example, the sub-pixel R_{1,2} is adjacent to the right side of the boundary of the sub-pixel corresponding to the first column line segment 31, the sub-pixel G_{2,2} is adjacent to the right side of the boundary of the sub-pixel corresponding to the second column line segment 32, and the sub-pixel B_{1,3} is adjacent to the right side of the boundary of the sub-pixel corresponding to the third line column segment 33 (i.e. one red sub-pixel, one green sub-pixel and one blue sub-pixel adjacent to the same sides of the predetermined boundaries).

Similarly, for the second sides (ex: the left sides) of the predetermined boundaries of the sub-pixels corresponding to each set of line segments, N1-2 and N2-2 and N3-2 are identical, and N1-2=N2-2=N3-2=1. As shown in FIG. 4A, for example, the sub-pixel B_{1,2} is adjacent to the left side of the boundary of the sub-pixel corresponding to the first column line segment 31, the sub-pixel R_{2,2} is adjacent to the left side of the boundary of the sub-pixel corresponding to the second column line segment 32, and the sub-pixel G_{1,2} is adjacent to the left side of the boundary of the sub-pixel corresponding to the third column line segment 33.

Similarly, N1-1 is equal to N1-2, N2-1 is equal to N2-2, and N3-1 is equal to N3-2 in the Embodiment 1-1, which means the numbers of the same colored sub-pixels respectively adjacent to two opposite sides (ex: right and left sides) of the predetermined boundaries of the sub-pixels corresponding to three column line segments (31-33) of each set are identical. Therefore, the covering parts of the different colored sub-pixels can be compensated each other to achieve the color balance.

Please refer to FIG. 4A, FIG. 4B-1 and FIG. 4B-2. As shown in FIG. 4B-1, when the right area of the touch display is viewed from the horizontal off axes (ex: from the horizontal off axis A_{H3} of FIG. 1C), the three line segments (i.e. 31-33) of each set respectively cover one of each colored sub-pixels such as one Red sub-pixel (ex: R_{1,2}), one Green sub-pixel (ex: G_{2,2}) and one Blue sub-pixel (ex: B_{1,3}). As shown in FIG. 4B-2, when the left area of the touch display is viewed from the horizontal off axes (ex: from the horizontal off axis A_{H1} of FIG. 1C), the three column line segments (i.e. 31-33) of each set also respectively cover one of each colored sub-pixels, such as one Red sub-pixel (ex: R_{2,2}), one Green sub-pixel (ex: G_{1,2}) and one Blue sub-pixel (ex: B_{1,2}). Therefore, the covering parts of the different colored sub-pixels, either from a single side or from different sides of viewing angles, are equal, so that the color balance would be achieved.

### Embodiment 1-2

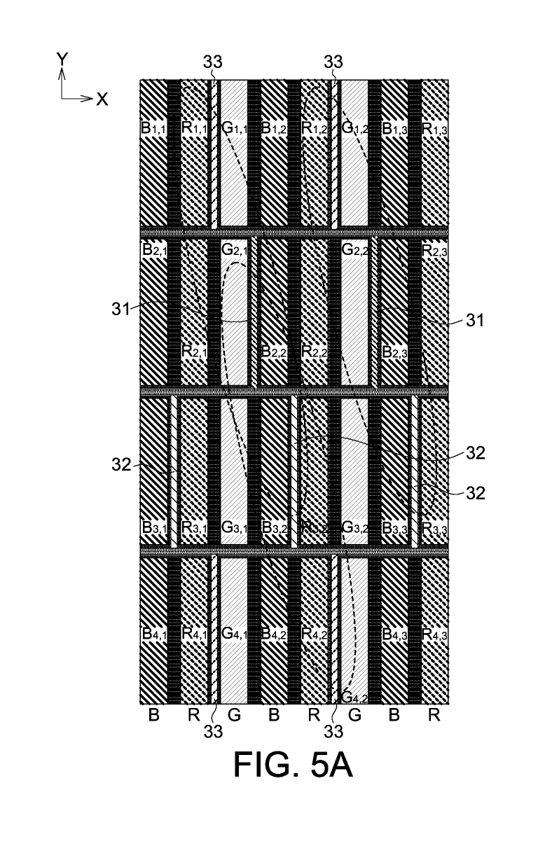

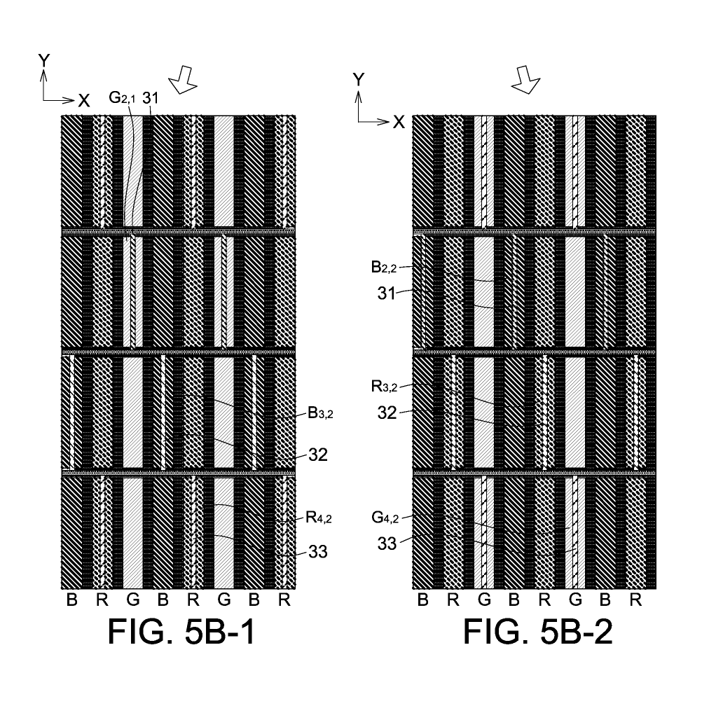

FIG. 5A illustrates several sets of line segments of a touch layer disposed correspondingly to the predetermined boundaries of the sub-pixels of a display device of a touch display according to the Embodiment 1-2 of the disclosure. FIG. 5B-1 and FIG. 5B-2 depict the configurations between the line segments and the sub-pixels of FIG. 4A at different horizontal viewing angles according to the Embodiment 1-2 of the disclosure.

In the Embodiment 1-2, as shown in FIG. 5A, each set of line segments comprises the first column line segment 31, the second column line segment 32 and the third column line segment 33 disposed correspondingly to the predetermined boundaries of the sub-pixels. Every combination of nearest 3 column line segments consisting of the first to three column line segments 31-33 is circled with the dash-lines in FIG. 5A for clear illustration.

As shown in FIG. 5A, the sub-pixels are arranged as a matrix with m rows and n columns (m and n are integers larger than 1), and the first (Red), second (Green) and third (Blue) colored sub-pixels are labeled as R_{1,1}, R_{1,2}, R_{1,3}, G_{1,1}, G_{1,2}, B_{1,1}, B_{1,2}, B_{1,3} (in the first row), R_{2,1}, R_{2,2}, R_{2,3}, G_{2,1}, G_{2,2}, B_{2,1}, B_{2,2}, B_{2,3} (in the second row), R_{3,1}, R_{3,2}, R_{3,3}, G_{3,1}, G_{3,2}, B_{3,1}, B_{3,2}, B_{3,3} (in the third row), and R_{4,1}, R_{4,2}, R_{4,3}, G_{4,1}, G_{4,2}, B_{4,1}, B_{4,2}, B_{4,3} (in the fourth row) etc. for illustration.

According to the Embodiment 1-2, N1-1=N2-1=N3-1=1. Take one set of line segments for example, the sub-pixel B_{2,2} is adjacent to the right side (i.e. the first side) of the boundary of the sub-pixel corresponding to the first column line segment 31, the sub-pixel R_{3,2} is adjacent to the right side of the boundary of the sub-pixel corresponding to the second column line segment 32, and the sub-pixel G_{4,2} is adjacent to the right side of the boundary of the sub-pixel corresponding to the third column line segment 33 (i.e. one red sub-pixel, one green sub-pixel and one blue sub-pixel adjacent to the same sides of the boundaries corresponding to each set of line segments).

Similarly, N1-2=N2-2=N3-2=1. For example, the sub-pixel G_{2,1} is adjacent to the left side (i.e. the second side opposite to the first side) of the boundary of the sub-pixel corresponding to the first column line segment 31, the sub-pixel B_{3,2} is adjacent to the left side of the boundary of the sub-pixel corresponding to the second column line segment 32, and the sub-pixel R_{4,2} is adjacent to the left side of the boundary of the sub-pixel corresponding to the third column line segment 33.

Similarly, N1-1 is equal to N1-2, N2-1 is equal to N2-2, and N3-1 is equal to N3-2 in the Embodiment 1-2, which means the numbers of the same colored sub-pixels respectively adjacent to two opposite sides (ex: right and left sides) of the predetermined boundaries of the sub-pixels corresponding to the three column line segments (31-33) of each set are identical. Therefore, the covering parts of the different colored sub-pixels can be compensated each other to achieve the color balance.

Also, in the Embodiment 1-2, the column line segments arranged correspondingly to the same row of the sub-pixels (such as two of the third column line segments 33 corresponding to the first row) are spaced apart by a distance corresponding to three sub-pixels. Also, the column line segments arranged correspondingly to the same column of the sub-pixels (such as two of the third column line segments 33 corresponding to the first R column) are spaced apart by a distance corresponding to two sub-pixels.

Please refer to FIG. 5A, FIG. 5B-1 and FIG. 5B-2. As shown in FIG. 5B-1, when the left area of the touch display is viewed from the horizontal off axes (ex: from the horizontal off axis A_{H1} of FIG. 1C), the three line segments (i.e. 31-33) of each set respectively cover one of each colored sub-pixels such as one Red sub-pixel (ex: R_{4,2}), one Green sub-pixel (ex: G_{2,1}) and one Blue sub-pixel (ex: B_{3,2}). As shown in FIG. 5B-2, when the right area of the touch display is viewed from the horizontal off axes (ex: from the horizontal off axis A_{H2} of FIG. 1C), the three line segments (i.e. 31-33) of each set also cover one of each colored sub-pixels, such as one Red sub-pixel (ex: R_{3,2}), one Green sub-pixel (ex: G_{4,2}) and one Blue sub-pixel (ex: B_{2,2}), respectively. Therefore, the covering parts of the different colored sub-pixels, either from a single side or from the different sides of the viewing angles, are equal, and the color balance can be achieved.

### Embodiment 1-3

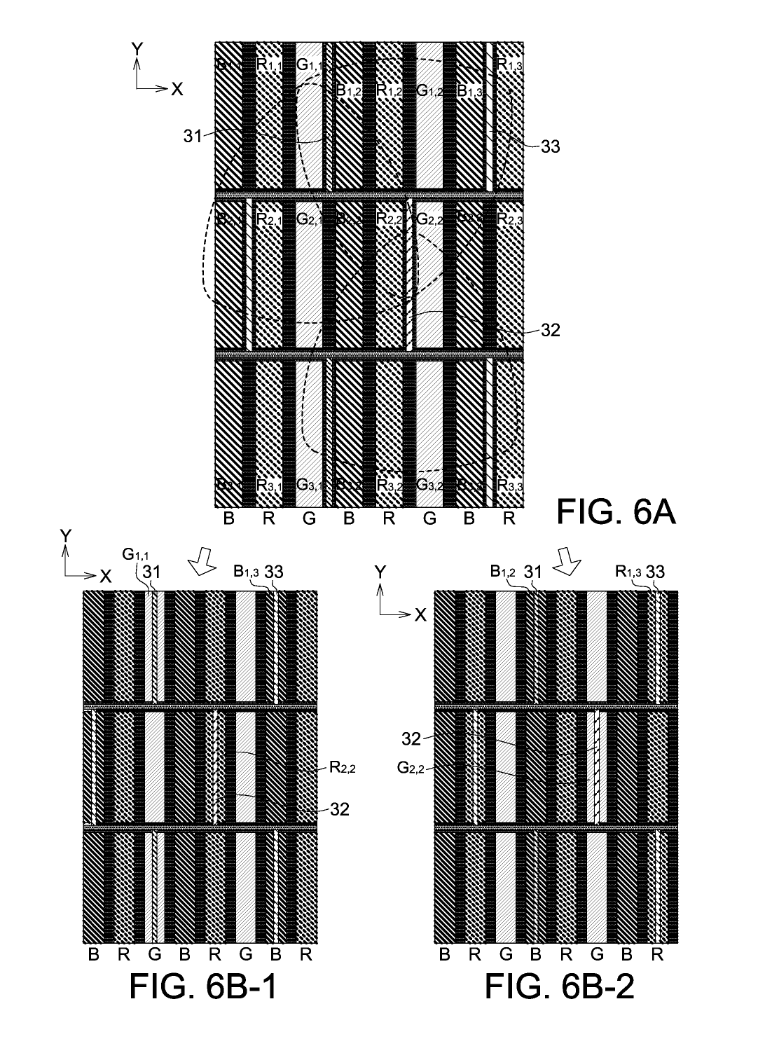

FIG. 6A illustrates several sets of line segments of a touch layer disposed correspondingly to the predetermined boundaries of the sub-pixels of a display device of a touch display according to the Embodiment 1-3 of the disclosure. FIG. 6B-1 and FIG. 6B-2 depict the configurations between the line segments and the sub-pixels of FIG. 6A at different horizontal viewing angles according to the Embodiment 1-3 of the disclosure.

Arrangement of the set of line segments in the Embodiment 1-3 is similar to that of the Embodiment 1-1, except for the distances for setting two of the three column line segments of each set disposed correspondingly to the adjacent rows of the sub-pixels.

In one embodiment, two of the three column line segments of each set disposed correspondingly to the adjacent rows of the sub-pixels are shifted by at least a distance corresponding to a sub-pixel, such as a distance of a sub-pixel side width, Wsub (please also see FIG. 3A). Please refer to FIG. 4A and FIG. 5A. In the Embodiments 1-1 and 1-2, two of the three column line segments of each set disposed correspondingly to the adjacent rows of the sub-pixels, such as the first column line segment 31 and the third column line segment 33, are shifted by a distance corresponding to a sub-pixel, such as a distance substantially equal to a sub-pixel side width, Wsub. Please refer to FIG. 6A. In the Embodiment 1-3, two of the three column line segments of each set disposed correspondingly to the adjacent rows of the sub-pixels, such as the first column line segment 31 and the third column line segment 33, are shifted by a distance corresponding to two sub-pixels, such as a distance substantially equal to two times the sub-pixel side width Wsub (i.e. 2×Wsub).

Every combination of nearest 3 column line segments consisting of the first to three column line segments 31-33 is circled with the dash-lines in FIG. 6A. Also, in the Embodiment 1-3, the line segments along the column direction (Y-direction) of the sub-pixels are arranged in every 2 of the sub-pixels.

According to the Embodiment 1-3, N1-1=N2-1=N3-1=1. Take one set of line segments for example, the sub-pixel B_{1,2} is adjacent to the right side (i.e. the first side) of the boundary of the sub-pixel corresponding to the first column line segment 31, the sub-pixel G_{2,2} is adjacent to the right side of the boundary of the sub-pixel corresponding to the second column line segment 32, and the sub-pixel R_{1,3} is adjacent to the right side of the boundary of the sub-pixel corresponding to the third column line segment 33 (i.e. one red sub-pixel, one green sub-pixel and one blue sub-pixel adjacent to the same sides of the boundaries corresponding to each set of line segments).

Similarly, N1-2=N2-2=N3-2=1. For example, the sub-pixel G_{1,1} is adjacent to the left side (i.e. the second side opposite to the first side) of the boundary of the sub-pixel corresponding to the first column line segment 31, the sub-pixel R_{2,2} is adjacent to the left side of the boundary of the sub-pixel corresponding to the second column line segment 32, and the sub-pixel B_{1,3} is adjacent to the left side of the boundary of the sub-pixel corresponding to the third column line segment 33.

Similarly, N1-1 is equal to N1-2, N2-1 is equal to N2-2, and N3-1 is equal to N3-2 in the Embodiment 1-3, which means the numbers of the same colored sub-pixels respectively adjacent to two opposite sides (ex: right and left sides) of the predetermined boundaries of the sub-pixels corresponding to the three column line segments (31-33) of each set are identical. Therefore, the covering parts of the different colored sub-pixels can be compensated each other to achieve the color balance.

Also, in the Embodiment 1-3, the column line segments arranged correspondingly to the same row of the sub-pixels (such as column line segments 31 and 33 corresponding to the first row) are spaced apart by a distance corresponding to four sub-pixels. Also, the column line segments arranged correspondingly to the same column of the sub-pixels (such as two of the first column line segments 31 corresponding to the G column) are spaced apart by a distance corresponding to one sub-pixel.

Please refer to FIG. 6A, FIG. 6B-1 and FIG. 6B-2. As shown in FIG. 6B-1, when the left area of the touch display is viewed from the horizontal off axes (ex: from the horizontal off axis A_{H1} of FIG. 1C), the three line segments (i.e. 31-33) of each set respectively cover one of each colored sub-pixels such as one Red sub-pixel (ex: R_{2,2}), one Green sub-pixel (ex: G_{1,1}) and one Blue sub-pixel (ex: B_{1,3}). As shown in FIG. 6B-2, when the right area of the touch display is viewed from the horizontal off axes (ex: from the horizontal off axis A_{H2} of FIG. 1C), the three line segments (i.e. 31-33) of each set also respectively cover one of each colored sub-pixels, such as one Red sub-pixel (ex: R_{1,3}), one Green sub-pixel (ex: G_{2,2}) and one Blue sub-pixel (ex: B_{1,2}). Therefore, the covering parts of the different colored sub-pixels, either from a single side or from different sides of the viewing angles, are equal, so that the color balance would be achieved.

In the aforementioned descriptions of Embodiments 1-1, 1-2 and 1-3, the sub-pixels of the display device can be arranged as a matrix in plural columns and rows, and the column line segments of the sets corresponding to adjacent rows of the sub-pixels are shifted by at least a distance corresponding to at least one of the sub-pixels (i.e. one sub-pixel for Embodiments 1-1 and 1-2, and two sub-pixels for Embodiment 1-3). According to the particular designs of the Embodiments 1-1, 1-2 and 1-3 (ex: N1-1=N2-1=N3-1 and/or N1-2=N2-2=N3-2), the sets of three column line segments compensate color unbalance, so that the color unbalance can be successfully avoided when the viewer watches the left and right areas of the touch display from the viewing angles along the horizontal off axes. Also, every row segment (coupled to the column line segments 31-33) of the metal mesh is aligned to R/G/B sub-pixel equally, and no color moiré issue occurs when the viewer watches the upper and lower areas of the touch display from viewing angles along the vertical off axes. Accordingly, no color moiré would be perceived in viewing the images displayed on the touch display of the Embodiments 1-1, 1-2 and 1-3.

### Embodiment 1-4

In the Embodiments 1-1 to 1-3, the sets of line segments comprising short column line segments are exemplified for illustration, wherein the length of the column line segments (Lc1 of FIG. 3A, along the Y-direction) is substantially equal to or slightly larger than a sub-pixel side length (Lsub of FIG. 3A). However, the length of the line segments of the disclosure is not limited to the types of short column line segments as shown in the Embodiments 1-1 to 1-3.

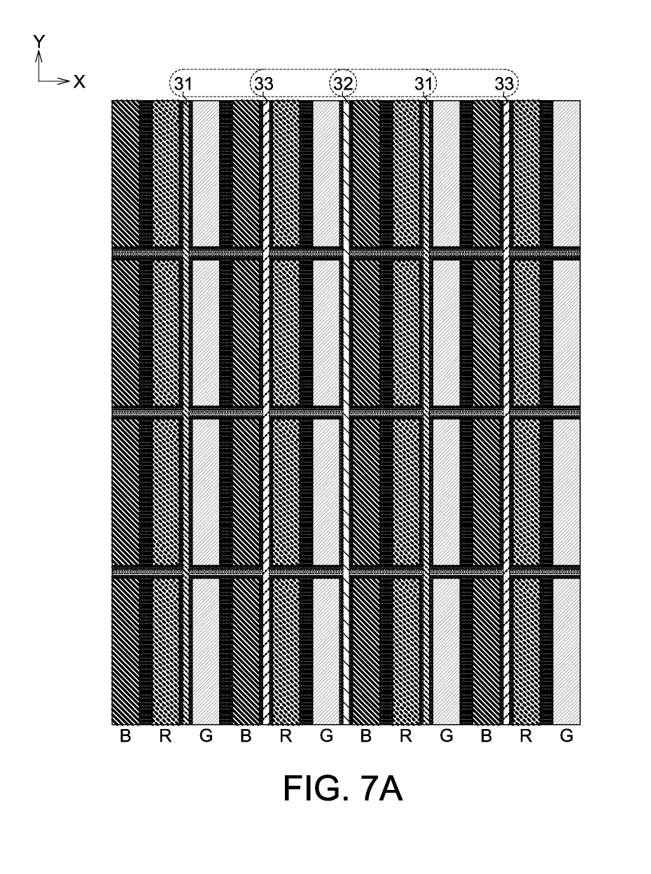

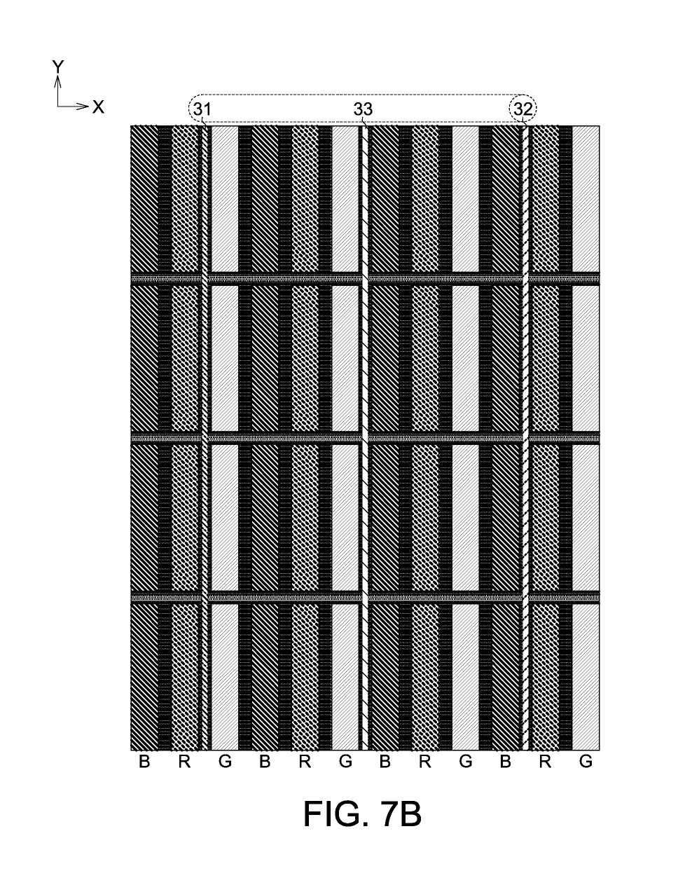

FIG. 7A and FIG. 7B illustrate several sets of line segments of two types of the touch layers disposed correspondingly to the predetermined boundaries of the sub-pixels of the display devices of the touch displays according to the Embodiment 1-4 of the disclosure. It is also assumed that the sub-pixels comprise three different colored (ex: RGB) sub-pixels and the three different colored sub-pixels are arranged as a (ex: RGB stripe arrangement) stripe arrangement. The arrangement of the set of line segments in FIG. 7A is similar to that of the Embodiment 1-3, except for the lengths of the three column line segments. The arrangement of the set of line segments in FIG. 7B is similar to that in FIG. 7A, except for the distances between the adjacent two of three column line segments of each set disposed correspondingly to the same row of the sub-pixels.

In Embodiment 1-4, the first column line segment 31 and the third column line segment 33 disposed adjacently correspondingly to the same row of the sub-pixels are spaced apart by a distance of about two times the sub-pixel side width Wsub (2×Wsub) of FIG. 7A (i.e. spaced apart by a distance corresponding to two sub-pixels), and four times the sub-pixel side width Wsub (4×Wsub) of FIG. 7B (i.e. spaced apart by a distance corresponding to four sub-pixels).

Similar to the arrangements of the Embodiments 1-1 to 1-3, as shown in FIG. 7A and FIG. 7B, the numbers of the different colored sub-pixels adjacent to same sides (ex: right sides or left sides) of the predetermined boundaries of the sub-pixels corresponding to the three column line segments (ex: 31-33) of each set are identical. Also, the numbers of the same colored sub-pixels respectively adjacent to two opposite sides (ex: right and left sides) of the predetermined boundaries of the sub-pixels corresponding to the three column line segments (ex: 31-33) of each set are identical.

According to the Embodiment 1-4, the sets of three column line segments still compensate the color unbalance. Compared to the conventional touch displays, the color unbalance situation can be significantly improved when the viewer watches the left and right areas of display viewing angles along the horizontal off axes, and color moiré may not be perceived in viewing the images displayed on the touch displays of the Embodiment 1-4.

### Second Embodiment

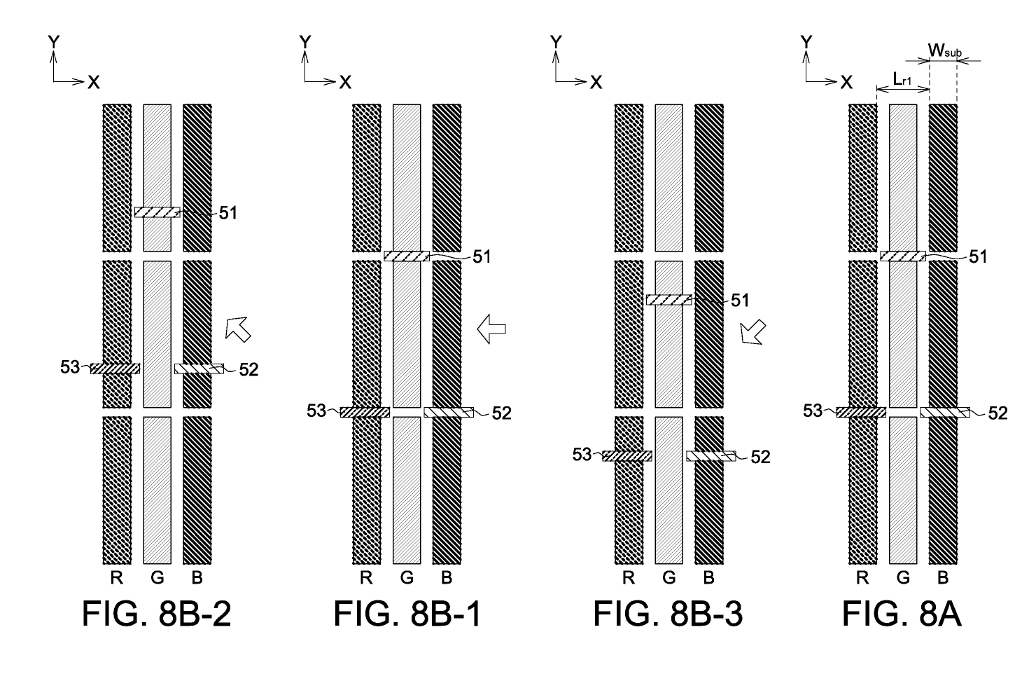

FIG. 8A illustrates one set of line segments of a touch layer disposed correspondingly to the predetermined boundaries of the sub-pixels of a display device of a touch display according to the second embodiment of the disclosure. FIG. 8B-1, FIG. 8B-2 and FIG. 8B-3 depict the configurations between the line segments and the sub-pixels of FIG. 8A at different vertical viewing angles according to the second embodiment of the disclosure.

The first and second embodiments have the same design concept of the sets of the line segments, except for the disposing directions of the line segments are changed. Different from the column line segments as exemplified in the first embodiment (including Embodiments 1-1 to 1-4), the sets of line segments of the second embodiment are row line segments parallel to the row direction (i.e. the rows of sub-pixels arranged along the X-direction) of the sub-pixels, as shown in FIG. 8A.

In the second embodiment, one set of line segments of the sensing unit (ex: a metal mesh) comprises three row line segments, such as a first row line segment 51, a second row line segment 52 and a third row line segment 53 disposed correspondingly to the predetermined boundaries of the sub-pixels, as shown in FIG. 8A. Also, the first sides and the second sides of the predetermined boundaries of the sub-pixels corresponding to the set of row line segments are upper sides and lower sides of the boundaries, respectively. In the second embodiment, the display device comprising three different colors of RGB sub-pixels is illustrated for exemplification.

According to the second embodiment, positions of the three row line segments of each set are arranged to compensate color unbalance each other when the upper and lower areas of the touch display is viewed from the vertical off axis. Please also refer to FIG. 1D for demonstrating the vertical viewing angles. As shown in FIG. 8A, two Green sub-pixels are respectively adjacent to the upper and lower sides of the first row line segment 51, two Blue sub-pixels are respectively adjacent to the upper and lower sides of the second row line segment 52, and two Red sub-pixels are respectively adjacent to the upper and lower sides of the third row line segment 53. Accordingly, N1-1=N2-1=N3-1=1 which means one G sub-pixel, one B sub-pixel and one R sub-pixel are adjacent to the upper sides of the predetermined boundaries of the sub-pixels (corresponding to the row line segments 51-53).

Similarly, N1-2=N2-2=N3-2=1, which means one G sub-pixel, one B sub-pixel and one R sub-pixel are adjacent to the lower sides of the predetermined boundaries of the sub-pixels.

Also, in one embodiment, N1-1 is equal to N1-2, N2-1 is equal to N2-2, and N3-1 is equal to N3-2, which means the numbers of the same colored sub-pixels respectively adjacent to two opposite sides of the predetermined boundaries of the sub-pixels corresponding to the three row line segments (51-53) of each set are identical. Please refer to FIG. 8A, and FIG. 8B-1 to FIG. 8B-3. As shown in FIG. 8B-1, when the central area of the touch display is viewed from the vertical on axis (ex: from the vertical on axis A_{V0} of FIG. 1D), images with correct colors and no loss of luminance are perceived by the viewer. As shown in FIG. 8B-2, when the upper area of the touch display is viewed from the vertical off axes (ex: from the vertical off axis A_{V1} of FIG. 1D), the three row line segments (i.e. 51-53) of each set respectively cover one of each colored sub-pixels such as one Red sub-pixel, one Green sub-pixel and one Blue sub-pixel. As shown in FIG. 8B-3, when the lower area of the touch display is viewed from the vertical off axes (ex: from the vertical off axis Aᵥ₂ of FIG. 1D), the three row line segments (i.e. 51-53) of each set also respectively cover one of each colored sub-pixels, such as one Red sub-pixel, one Green sub-pixel and one Blue sub-pixel. Therefore, the covering parts of the different colored sub-pixels are compensated each other to achieve the color balance. Accordingly, the color unbalance can be successfully avoided when the viewer watches the upper and lower areas of the touch display from viewing angles along the vertical off axes. No color moiré would be perceived in viewing the images displayed on the touch displays of the embodiments.

Embodiments 2-1 and 2-2 are provided below for elaborating some of possible designs of each set of the row line segments, based on the design concepts of the second embodiment.

### Embodiment 2-1

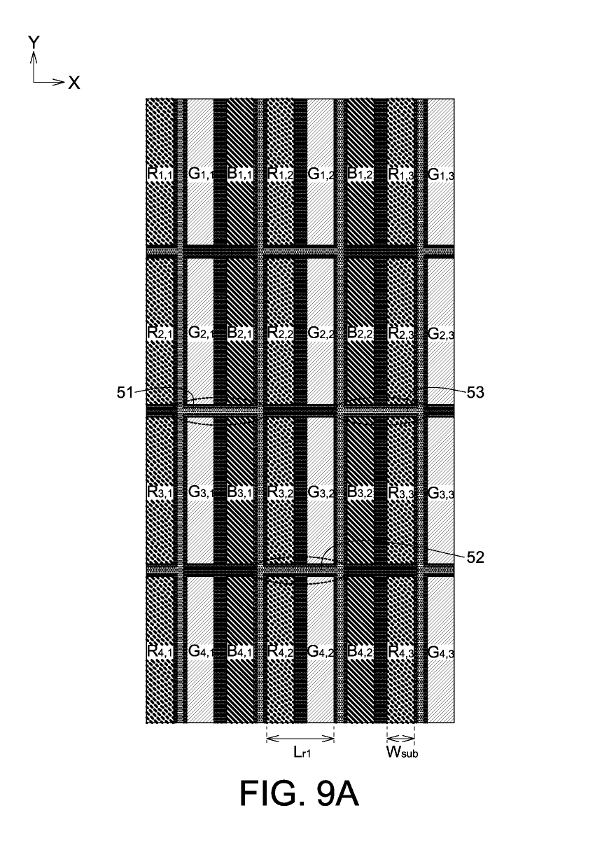

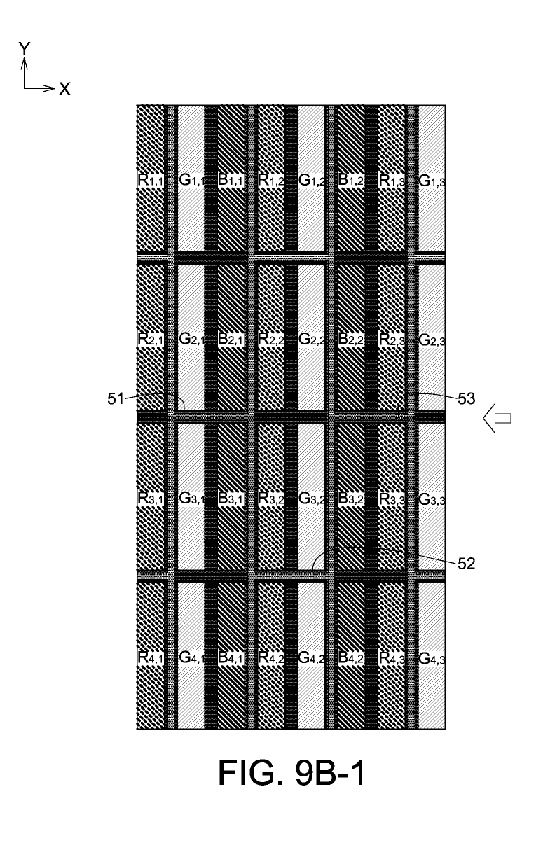

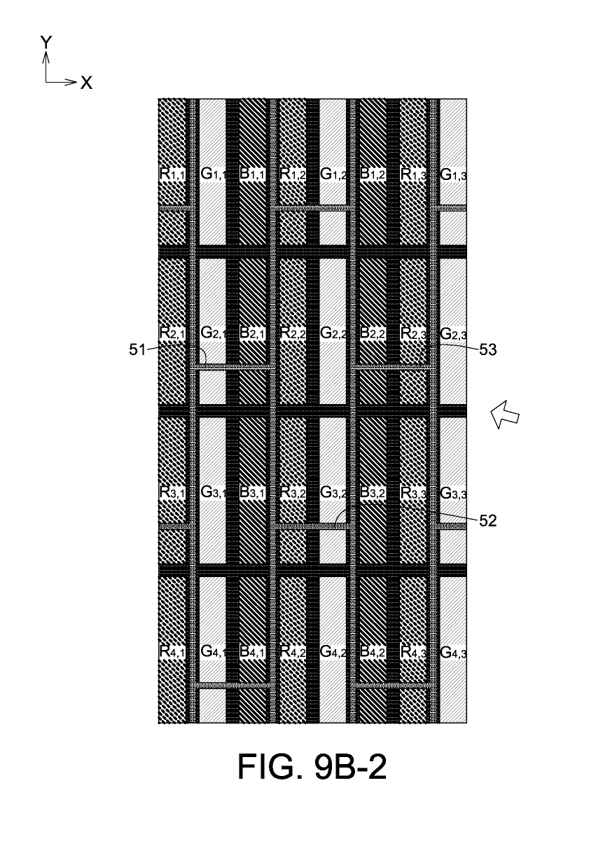

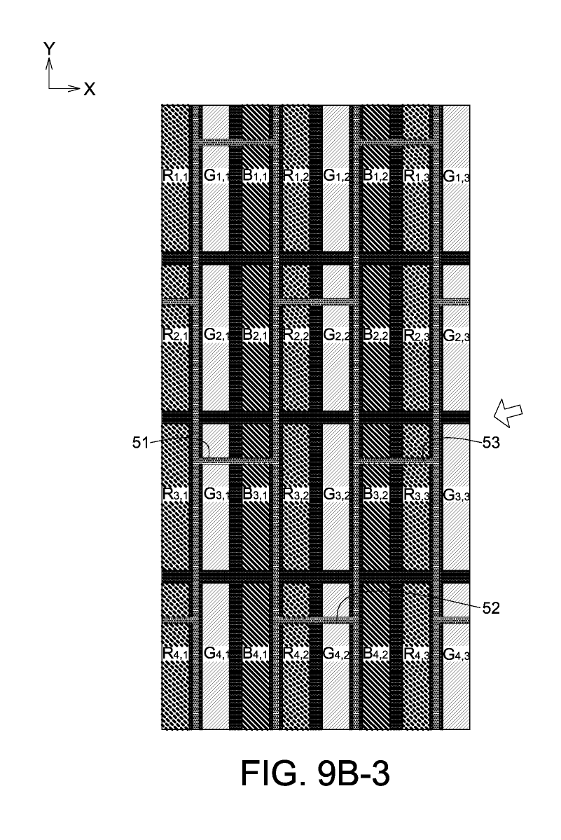

FIG. 9A illustrates several sets of line segments of a touch layer disposed correspondingly to the predetermined boundaries of the sub-pixels of a display device of a touch display according to the Embodiment 2-1 of the disclosure. FIG. 9B-1, FIG. 9B-2 and FIG. 9B-3 depict the configurations between the line segments and the sub-pixels of FIG. 9A at different vertical viewing angles according to the Embodiment 2-1 of the disclosure. In the Embodiment 2-1, each set of line segments comprises the first row line segment 51, the second row line segment 52 and the third row line segment 53 disposed correspondingly to the predetermined boundaries of the sub-pixels.

According to the Embodiment 2-1, one of the row line segments along the row direction (i.e. X-direction) of the sub-pixels is disposed correspondingly in the boundaries of two sub-pixels, as shown in FIG. 9A.

In the second embodiment, the sub-pixels can be arranged as a matrix with m rows and n columns (i.e. m×n matrix or m-by-n matrix), m and n are integers larger than 1. As shown in FIG. 9A, the first (Red), second (Green) and third (Blue) colored sub-pixels are labeled as R_{1,1}, R_{1,2}, R_{1,3}, G_{1,1}, G_{1,2}, G_{1,3}, B_{1,1}, B_{1,2} (in the first row), R_{2,1}, R_{2,2}, R_{2,3}, G_{2,1}, G_{2,2}, G_{2,3}, B_{2,1}, B_{2,2} (in the second row), R_{3,1}, R_{3,2}, R_{3,3}, G_{3,1}, G_{3,2}, G_{3,3}, B_{3,1}, B_{3,2} (in the third row) and R_{4,1}, R_{4,2}, R_{4,3}, G_{4,1}, G_{4,2}, G_{4,3}, B_{4,1}, B_{4,2} (in the fourth row) etc. for illustration.

According to the Embodiment 2-1, N1-1 is equal to N2-1 and equal to N3-1 and equal to 2. Take one set of row line segments for example. As shown in FIG. 9A, the sub-pixels G_{2,1} and B_{2,1} are adjacent to the upper side (i.e. the first side) of the boundaries of the sub-pixels corresponding to the first row line segment 51, the sub-pixels R_{3,2} and G_{3,2} are adjacent to the upper side of the boundaries of the sub-pixels corresponding to the second row line segment 52, and the sub-pixels B_{2,2} and R_{2,3} are adjacent to the upper side of the boundaries of the sub-pixels corresponding to the third row line segment 53. Thus, two R, two G and two B sub-pixels adjacent to the same sides of the predetermined boundaries (corresponding to each set of row line segments 51-53).

Similarly, N1-2=N2-2=N3-2=2. Take one set of row line segments for example, the sub-pixels G_{3,1} and B_{3,1} are adjacent to the lower side (i.e. the second side opposite to the first side) of the boundaries of the sub-pixels corresponding to the first row line segment 51, the sub-pixels R_{4,2} and G_{4,2} are adjacent to the lower side of the boundaries of the sub-pixels corresponding to the second row line segment 52, and the sub-pixels B_{3,2} and R_{3,3} are adjacent to the lower side of the boundaries of the sub-pixels corresponding to the third row line segment 53.

Similarly, N1-1 is equal to N1-2 (=2), N2-1 is equal to N2-2 (=2), and N3-1 is equal to N3-2 (=2) in the Embodiment 2-1, which means the numbers of the same colored sub-pixels respectively adjacent to two opposite sides (ex: upper and lower sides) of the predetermined boundaries of the sub-pixels corresponding to the three row line segments (51-53) of each set are identical. Therefore, the covering parts of the different colored sub-pixels can be compensated each other to achieve the color balance.

Also, in the Embodiment 2-1, the row line segments arranged correspondingly to the same row of the sub-pixels (such as the row line segments 51 and 53 corresponding to the second row) are spaced apart by a distance corresponding to two sub-pixels. Also, the row line segments arranged correspondingly to the same column of the sub-pixels (such as the row line segments 52 corresponding to the R and G columns) are spaced apart by a distance corresponding to two sub-pixels.

Please refer to FIG. 9A, FIG. 9B-1, FIG. 9B-2 and FIG. 9B-3. As shown in FIG. 9B-1, when the central area of the touch display is viewed from the vertical on axis (ex: from the vertical on axis A_{V0} of FIG. 1D), images with correct colors and no loss of luminance are perceived by the viewer. As shown in FIG. 9B-2, when the upper area of the touch display is viewed from the vertical off axes (ex: from the vertical off axis A_{V1} of FIG. 1D), the three row line segments (51-53) of each set respectively cover two of each colored sub-pixels, such as two Red sub-pixels (ex: R_{3,2} and R_{2,3}), two Green sub-pixels (ex: G_{2,1} and G_{3,2}) and two Blue sub-pixels (ex: B_{2,1} and B_{2,2}). As shown in FIG. 9B-3, when the lower area of the touch display is viewed from the vertical off axes (ex: from the vertical off axis A_{V2} of FIG. 1D), the three row line segments (i.e. 51-53) of each set also respectively cover two of each colored sub-pixels, such as two Red sub-pixels (ex: R_{4,2} and R_{3,3}), two Green sub-pixels (ex: G_{3,1} and G_{4,2}) and two Blue sub-pixels (ex: B_{3,1} and B_{3,2}). Therefore, the covering parts of the different colored sub-pixels, either from a single side or from different sides of vertical viewing angles, are equal, so that the color balance would be achieved.

### Embodiment 2-2

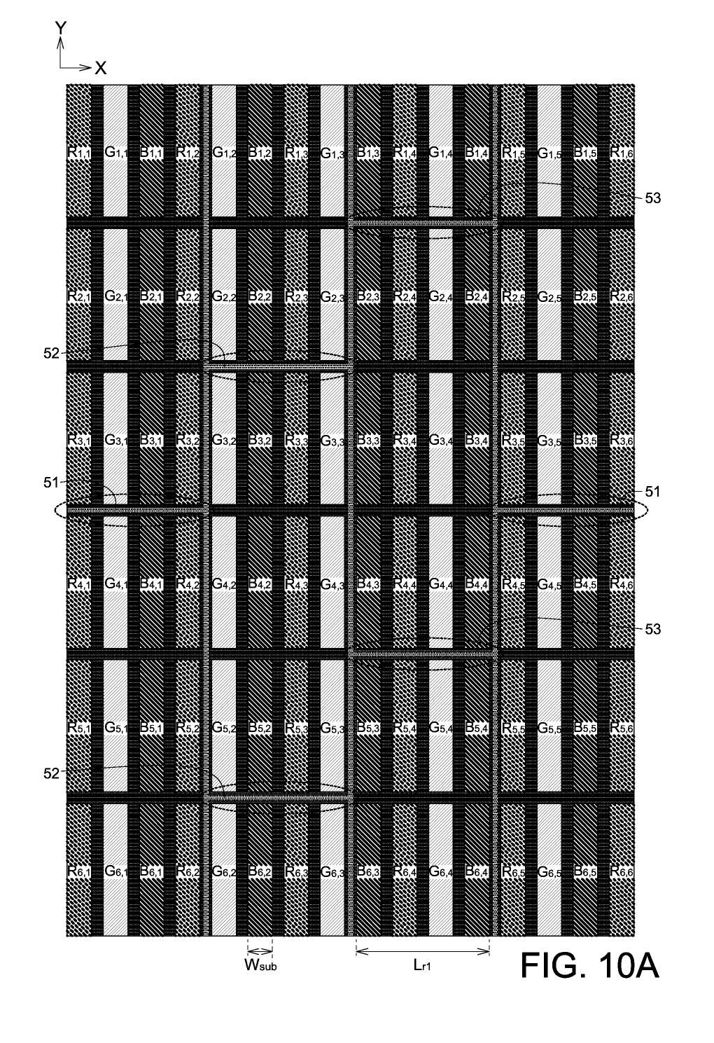

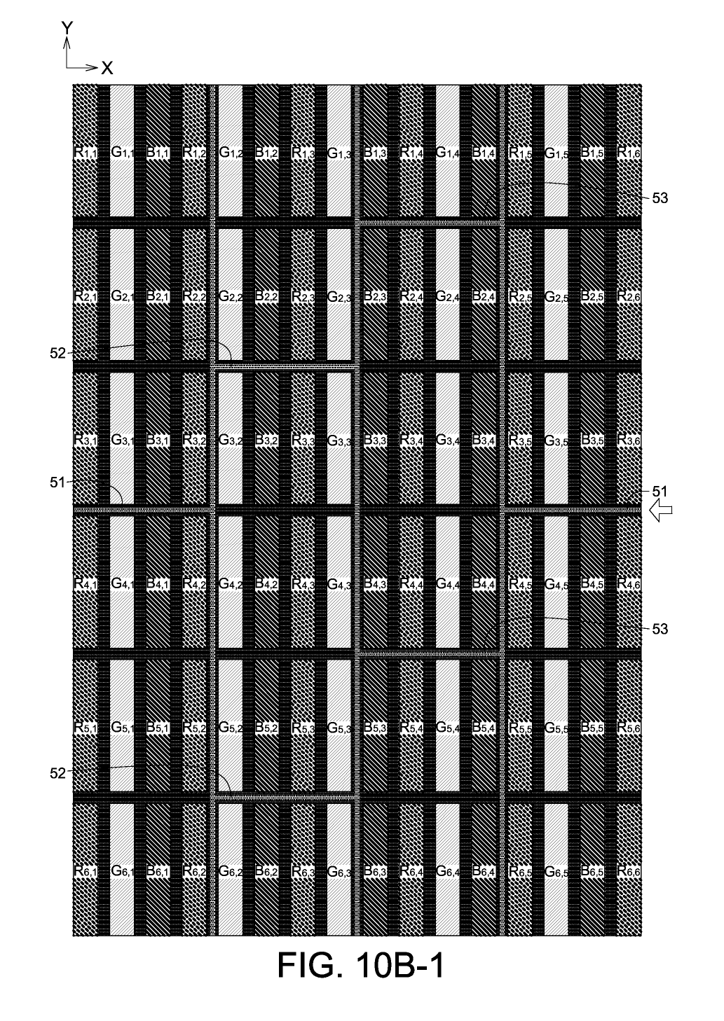

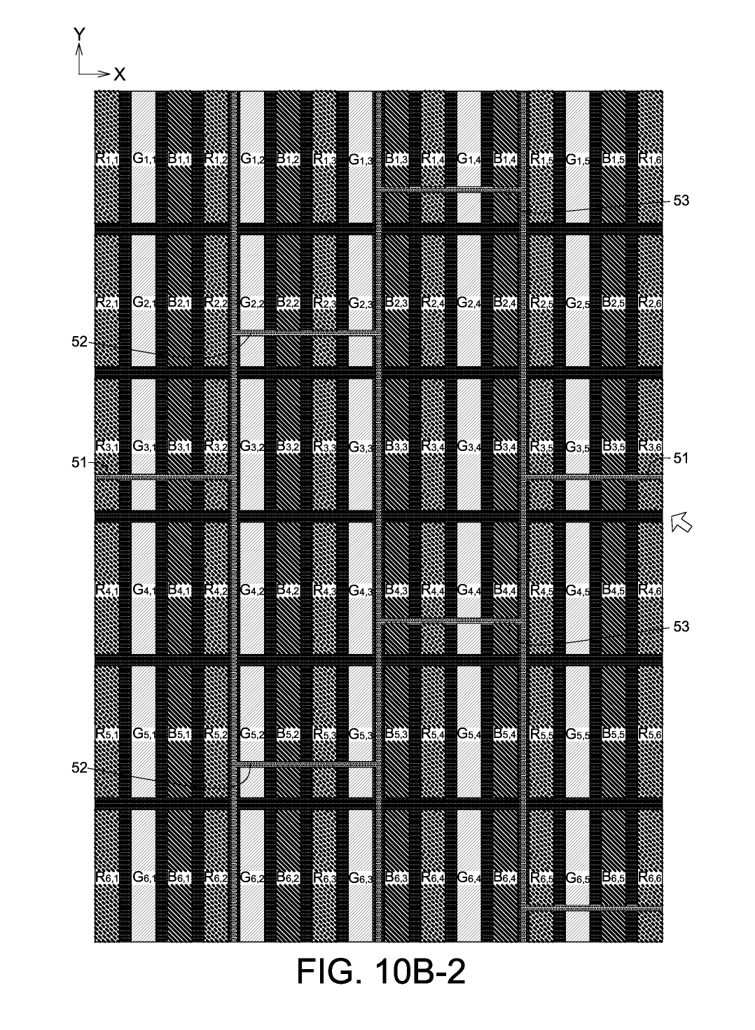

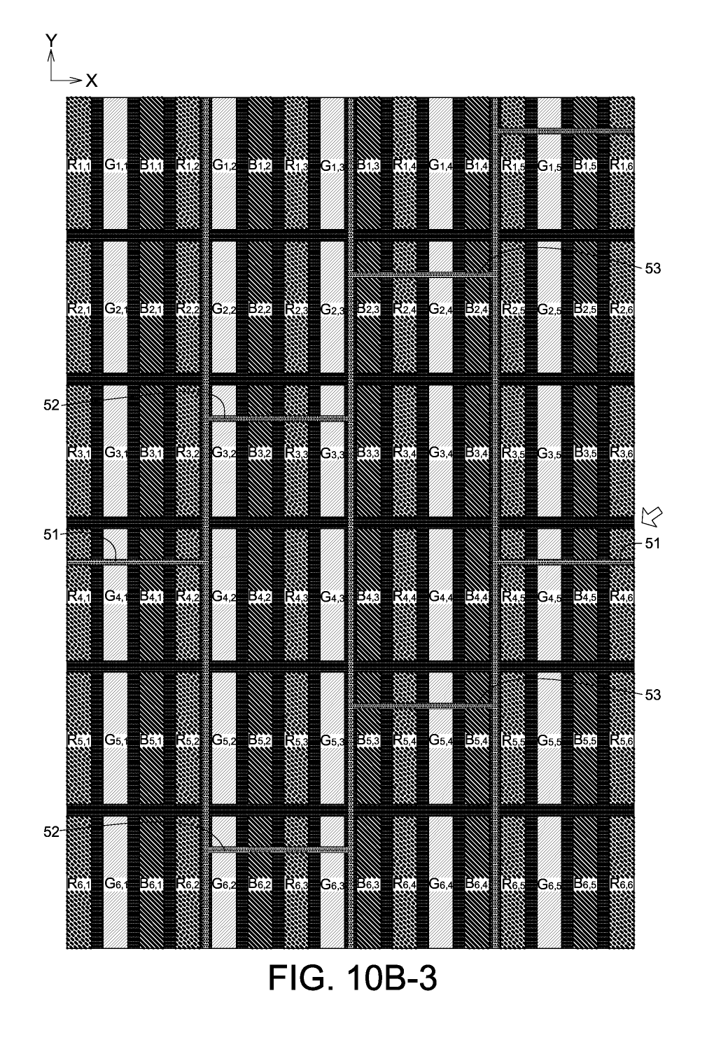

FIG. 10A illustrates several sets of line segments of a touch layer disposed corresponding to the predetermined boundaries of the sub-pixels of a display device of a touch display according to the Embodiment 2-2 of the disclosure. FIG. 10B-1, FIG. 10B-2 and FIG. 10B-3 depict the configurations between the line segments and the sub-pixels of FIG. 10A at different vertical viewing angles according to the Embodiment 2-2 of the disclosure. In the Embodiment 2-2, as shown in FIG. 10A, each set of line segments comprises a first row line segment 51, a second row line segment 52 and a third row line segment 53 disposed corresponding to the predetermined boundaries of the sub-pixels along the row direction.

According to the Embodiment 2-2, one of the row line segments along the row direction (i.e. X-direction) of the sub-pixels is disposed correspondingly in the boundaries of four sub-pixels.

Arrangement of the set of line segments in the Embodiment 2-2 is similar to that of the Embodiment 2-1, except for the lengths of each of the row line segments. In the Embodiment 2-1, the length of each row line segments (Lr1) extending along the row direction (X-direction) is substantially equal to or slightly larger than two times the sub-pixel side width (2×Wsub). In the Embodiment 2-2, the length of each row line segments (Lr1) extending along the row direction (X-direction) is substantially equal to or slightly larger than four times the sub-pixel side width (4×Wsub).

Also, in the Embodiment 2-2, the row line segments arranged correspondingly to the same row of the sub-pixels (such as two of the first row line segments 51 corresponding to the third row) are spaced apart by a distance corresponding to eight sub-pixels. Also, the row line segments arranged correspondingly to the same column of the sub-pixels (such as two of the second row line segments 52 corresponding to the same columns) are spaced apart by a distance corresponding to three sub-pixels.

Also, according to the Embodiment 2-2, N1-1=N2-1=N3-1=4. Take one set of row line segments (51-53) for example, as shown in FIG. 10A, the sub-pixels R_{3,1}, G_{3,1}, B_{3,1} and R_{3,2} are adjacent to the upper side of the predetermined boundaries of the sub-pixels corresponding to the first row line segment 51, the sub-pixels G_{2,2}, B_{2,2}, R_{2,3} and G_{2,3} are adjacent to the upper side of the predetermined boundaries of the sub-pixels corresponding to the second row line segment 52, and the sub-pixels B_{1,3}, R_{1,4}, G_{1,4} and B_{1,4} are adjacent to the upper side of the predetermined boundaries of the sub-pixels corresponding to the third row line segment 53 (i.e. four R, four G and four B sub-pixels adjacent to the same sides of the boundaries corresponding to each set of row line segments).

Similarly, N1-2=N2-2=N3-2=4. Take one set of row line segments for example, the sub-pixels R_{4,1}, G_{4,1}, B_{4,1} and R_{4,2} are adjacent to the lower side of the predetermined boundaries of the sub-pixels corresponding to the first row line segment 51, the sub-pixels G_{3,2}, B_{3,2}, R_{3,3} and G_{3,3} are adjacent to the lower side of the predetermined boundaries of the sub-pixels corresponding to the second row line segment 52, and the sub-pixels B_{2,3}, R_{2,4}, G_{2,4} and B_{2,4} are adjacent to the lower side of the predetermined boundaries of the sub-pixels corresponding to the third row line segment 53.

Similarly, N1-1 is equal to N1-2 (=4), N2-1 is equal to N2-2 (=4), and N3-1 is equal to N3-2 (=4) in the Embodiment 2-2, which means the numbers of the same colored sub-pixels respectively adjacent to two opposite sides (ex: upper and lower sides) of the predetermined boundaries of the sub-pixels corresponding to the three row line segments (51-53) of each set are identical. Therefore, the covering parts of the different colored sub-pixels can be compensated each other to achieve the color balance.

Please refer to FIG. 10A, FIG. 10B-1, FIG. 10B-2 and FIG. 10B-3. As shown in FIG. 10B-1, when the central area of the touch display is viewed from the vertical on axis (ex: from the vertical on axis A_{V0} of FIG. 1D), images with correct colors and no loss of luminance are perceived by the viewer. As shown in FIG. 10B-2, when the upper area of the touch display is viewed from the vertical off axes (ex: from the vertical off axis A_{V1} of FIG. 1D), the three row line segments (51-53) of each set respectively cover four of each colored sub-pixels, such as four Red sub-pixels (ex: R_{3,1}, R_{3,2}, R_{2,3} and R_{1,4}), four Green sub-pixels (ex: G_{3,1}, G_{2,2}, G_{2,3} and G_{1,4}) and four Blue sub-pixels (ex: B_{3,1}, B_{2,2}, B_{1,3} and B_{1,4}). As shown in FIG. 10B-3, when the lower area of the touch display is viewed from the vertical off axes (ex: from the vertical off axis A_{V2} of FIG. 1D), the three row line segments (i.e. 51-53) of each set also respectively cover four of each colored sub-pixels, such as four Red sub-pixels (ex: R_{4,1}, R_{4,2}, R_{3,3} and R_{2,4}), four Green sub-pixels (ex: G_{4,1}, G_{3,2}, G_{3,3} and G_{2,4}) and four Blue sub-pixels (ex: B_{4,1}, B_{3,2}, B_{2,3} and B_{2,4}). Therefore, the covering parts of the different colored sub-pixels, either from a single side or from different sides of vertical viewing angles, are equal, so that the color balance would be achieved.

In the aforementioned descriptions of Embodiments 2-1 and 2-2, the sub-pixels of the display device can be arranged as a matrix in plural columns and rows, and the row line segments of the sets corresponding to adjacent rows of the sub-pixels (such as row line segments 52 and 53 in FIG. 9A and FIG. 10A) are also shifted by at least a distance corresponding to one of the sub-pixels. According to the particular designs of the Embodiments 2-1 and 2-2 (ex: N1-1=N2-1=N3-1 and/or N1-2=N2-2=N3-2), the color unbalance can be successfully avoided when the viewer watches the upper and lower areas of the touch display from viewing angles along the vertical off axes. Also, no color moiré issue occurs when the viewer watches the display from horizontal viewing angles along the horizontal off axes. Accordingly, no color moiré would be perceived in viewing the images displayed on the touch display of the Embodiments 2-1 and 2-2.

Although the sub-pixels of the display device in the first and second embodiments comprising three different colors, such as R, G and B sub-pixels, the disclosure is not limited to RGB sub-pixels in the practical applications.

The display device with four different colors, such as R, G, B and W (white) sub-pixels can be applied by the designs of the column/row line segments, and some embodied applications are provided in the third and fourth embodiments of the disclosure.

### Third Embodiment

In the third embodiment, each set of line segments comprises four line segments, which includes the first line segment 61, the second line segment 62, the third line segment 63 and the fourth line segment 64 disposed correspondingly to the predetermined boundaries of the sub-pixels. Also, the sub-pixels of the third embodiment comprising four different colors is illustrated for exemplification, including a first colored sub-pixels (such as Red sub-pixels, “R” in the figures), a second colored sub-pixels (such as Green sub-pixels, “G” in the figures), a third colored sub-pixels (such as Blue sub-pixels, “B” in the figures) and a fourth colored sub-pixels (such as white sub-pixels, “W” in the figures) arranged as a RGBW-stripe pattern.

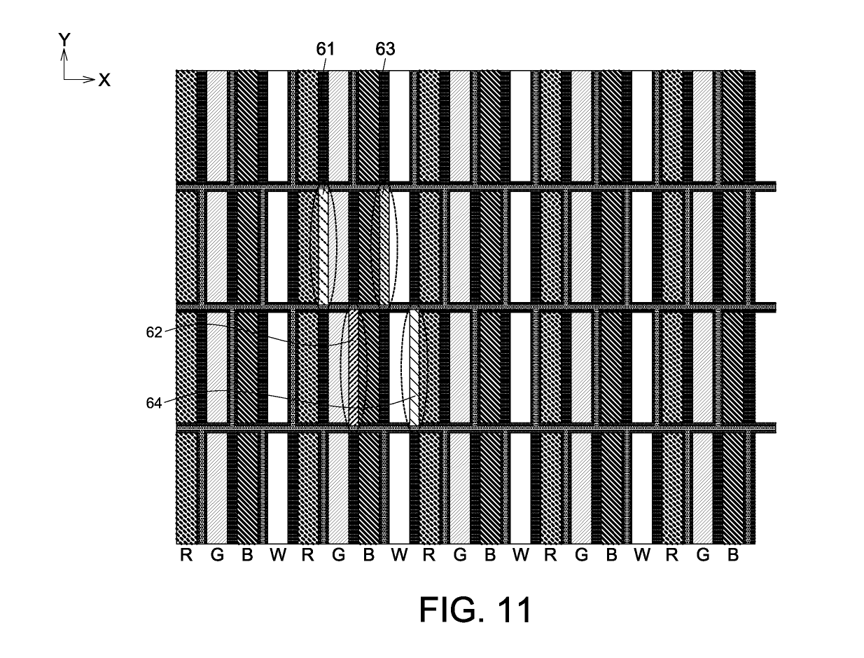

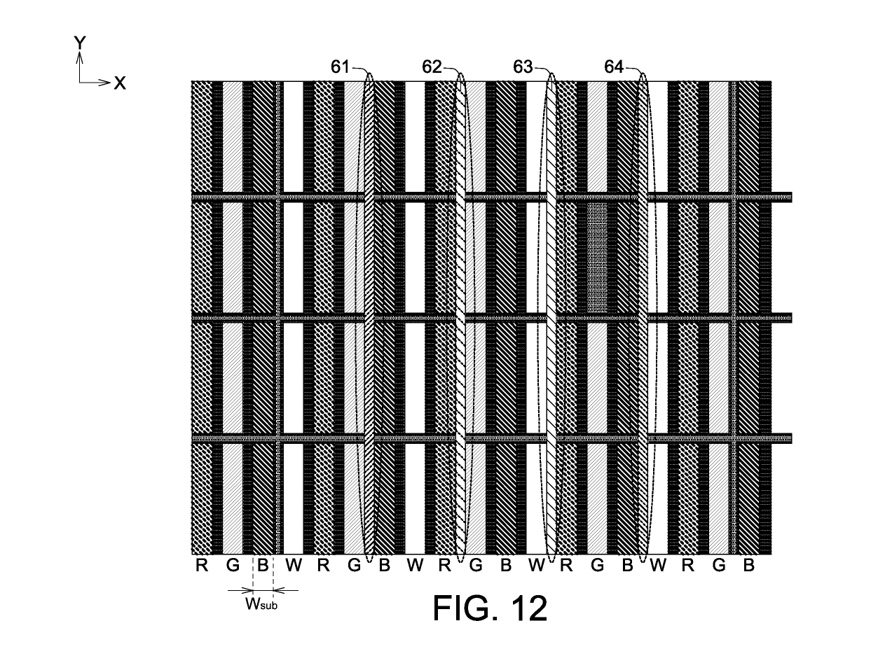

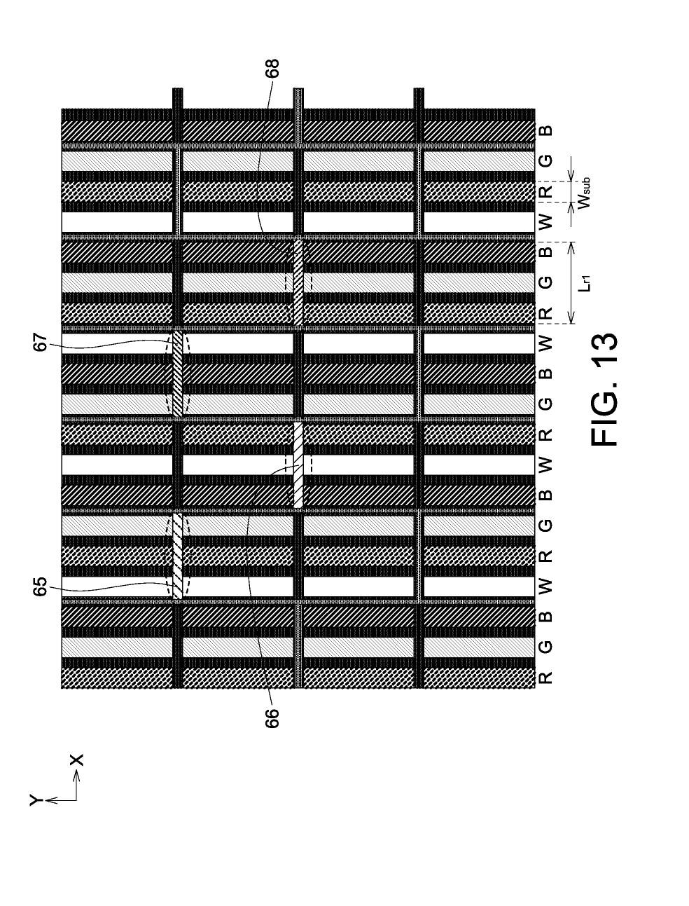

Embodiments 3-1, 3-2 and 3-3 are provided below for elaborating some possible designs of each set of four column or row line segments, based on the design concepts of the third embodiment. FIG. 11, FIG. 12 and FIG. 13 illustrate several sets of line segments of a touch layer disposed correspondingly to the predetermined boundaries of the sub-pixels of a display device of a touch display according to the Embodiments 3-1, 3-2 and 3-3 of the disclosure, respectively.

Arrangement and color compensation effect of the sets of column line segments in the Embodiment 3-1 are similar to that of the Embodiment 1-1, except for the numbers of the line segments of each set and the sub-pixel colors (i.e. each set comprising three column line segments and RGB sub-pixels arranged in the Embodiment 1-1, and each set comprising four column line segments and RGBW sub-pixels arranged in the Embodiment 3-1). Please refer to the first embodiment such as the Embodiment 1-1 for the details of each set of the column line segments and the colored sub-pixels corresponding to the column line segments, and those contents are not redundantly repeated herein. Also, in the Embodiment 3-1, the column line segments arranged correspondingly to the same row of the sub-pixels (ex: 61 and 63) are spaced apart by a distance corresponding to two sub-pixels. Also, the column line segments arranged correspondingly to the same column of the sub-pixels (ex: two of the first column line segments 61) are spaced apart by a distance corresponding to one sub-pixel.

In the Embodiment 3-1, the numbers of the same colored sub-pixels respectively adjacent to two opposite sides (ex: right and left sides) of the predetermined boundaries of the sub-pixels corresponding to four column line segments (61-64) of each set are identical. For example, one R sub-pixel, one G sub-pixel, one B sub-pixel and one W sub-pixel are respectively adjacent to the right sides (and also the left sides) of the predetermined boundaries of the sub-pixels corresponding to four column line segments (61-64) of each set. Therefore, the covering parts of the different colored sub-pixels can be compensated each other to achieve the color balance. Therefore, according to the Embodiment 3-1, the color unbalance can be successfully avoided when the viewer watches the left and right areas of the touch display from viewing angles along the horizontal off axes. Also, every row segment (coupled to the column line segments 61-64) of the metal mesh is aligned to R/G/B/W sub-pixel equally, and no color moiré issue occurs when the viewer watches the upper and lower areas of the touch display from viewing angles along the vertical off axes. Accordingly, no color moiré would be perceived in viewing the images displayed on the touch display of the Embodiment 3-1.

Arrangement and color compensation effect of the sets of column line segments in the Embodiment 3-2 are similar to that of the Embodiment 1-4, except for the numbers of the line segments of each set and the sub-pixel colors (i.e. each set comprising three column line segments and RGB sub-pixels arranged in the Embodiment 1-4, and each set comprising four column line segments and RGBW sub-pixels arranged in the Embodiment 3-2), and in particular, the distance between the adjacent two of the column line segments of each set disposed correspondingly to the same row of the sub-pixels. According to the Embodiment 3-2, the column line segments 61-64 are set in every three sub-pixels along the row direction (i.e. X-direction) of the sub-pixels. Thus, two of the line segments disposed adjacently (such as the first line segment 61 and the second line segment 62) corresponding to the same row of the sub-pixels are spaced apart by a distance of about three times the sub-pixel side width Wsub (3×Wsub), as shown in FIG. 12. Please refer to the first embodiment such as the Embodiment 1-4 for other details of each set of the column line segments and the colored sub-pixels corresponding to the column line segments. Compared to the conventional touch displays, the sets of four column line segments of the Embodiment 3-2 still compensate the color unbalance, and the color unbalance situation can be significantly improved when the viewer watches the left and right areas of the touch display from viewing angles along the horizontal off axes, and color moiré may not be perceived in viewing the images displayed on the touch display of the Embodiment 3-2. Noted that arrangements of the sets of the line segments as shown in FIG. 7A, FIG. 7B and FIG. 12 are suitable for applying to the touch displays with high-resolution (high-PPI) display devices.

Arrangement and color compensation effect of the sets of row line segments in the Embodiment 3-3 are similar to that of the Embodiment 2-1, except for the numbers of the line segments of each set, the sub-pixel colors (i.e. each set comprising three row line segments and RGB sub-pixels arranged in the Embodiment 2-1, and each set comprising four row line segments 65-68 and RGBW sub-pixels arranged in the Embodiment 3-3), and in particular, the length of each row line segment disposed correspondingly to the sub-pixels. As shown in FIG. 13, the length of each row line segment (65/66/67/68) is corresponding to the boundaries of three adjacent sub-pixels. Also, in the Embodiment 3-3, the row line segments arranged correspondingly to the same row of the sub-pixels (ex: 65 and 37 corresponding to the first row) are spaced apart by a distance corresponding to three sub-pixels. Also, the row line segments arranged correspondingly to the same column of the sub-pixels (such as two of the row line segments 65) are spaced apart by a distance corresponding to two sub-pixels. Please refer to the second embodiment such as the Embodiment 2-1 for other details of each set of the row line segments and the colored sub-pixels corresponding to the row line segments.

In the Embodiment 3-3, the numbers of the same colored sub-pixels respectively adjacent to two opposite sides (ex: upper and lower sides) of the predetermined boundaries of the sub-pixels corresponding to four row line segments (65-68) of each set are identical. For example, three R sub-pixels, three G sub-pixels, three B sub-pixels and three W sub-pixels are respectively adjacent to the upper sides (and also the lower sides) of the predetermined boundaries of the sub-pixels corresponding to four row line segments (65-68) of each set. The covering parts of the different colored sub-pixels can be compensated each other to achieve the color balance. Therefore, according to the Embodiment 3-3, the color unbalance can be successfully avoided when the viewer watches the upper and lower areas of the touch display from viewing angles along the vertical off axes. Also, every column segment (coupled to the row line segments 65-68) of the metal mesh is aligned to R/G/B/W sub-pixel equally, and no color moiré issue occurs when the viewer watches the right and left areas of the touch display from viewing angles along the horizontal off axes. Accordingly, no color moiré would be perceived in viewing the images displayed on the touch display of the Embodiment 3-3.

In the aforementioned descriptions of Embodiments 3-1 and 3-3, the sub-pixels of the display device can be arranged as a matrix in plural columns and rows, and the column or row line segments of the sets corresponding to adjacent rows of the sub-pixels are shifted by at least a distance corresponding to at least one of the sub-pixels (i.e. two sub-pixels for Embodiments 3-1, and one sub-pixels for Embodiment 3-3). According to the particular designs of the third Embodiment (ex: N1-1=N2-1=N3-1 and/or N1-2=N2-2=N3-2), the color unbalance issue can be solved.

### Fourth Embodiment

In the fourth embodiment, each set of line segments comprises four line segments disposed correspondingly to the predetermined boundaries of the sub-pixels, and four different colored sub-pixels such as R, G, B and W sub-pixels are arranged as a RGBW-quadrant pattern. Embodiments 4-1, 4-2 and 4-3 are provided below for elaborating some of possible designs of each set of four column or row line segments, based on the design concepts of the fourth embodiment.

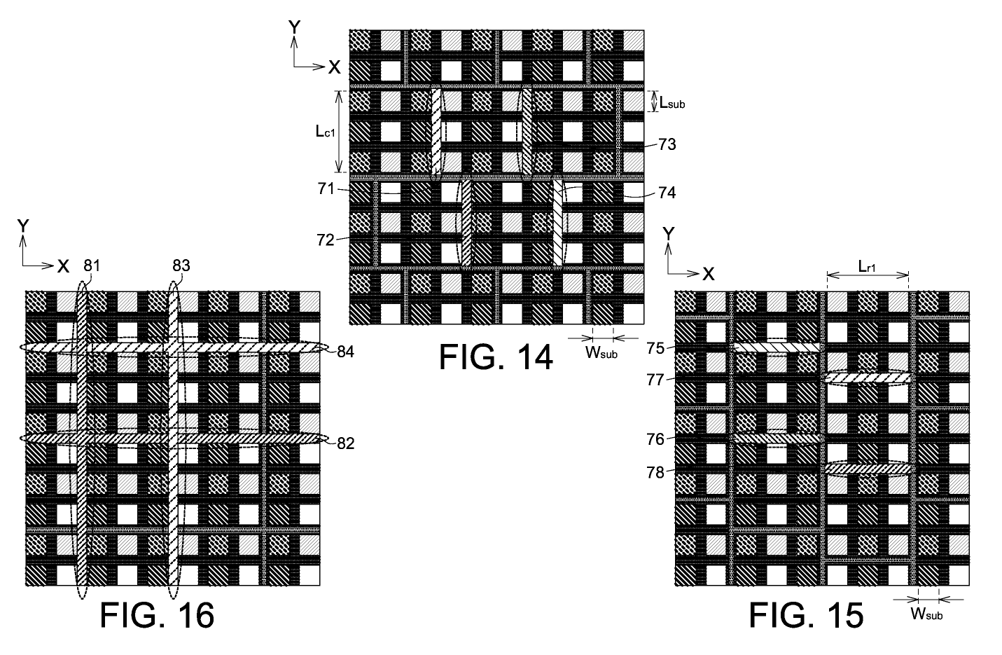

FIG. 14, FIG. 15 and FIG. 16 illustrate several sets of line segments of a touch layer disposed correspondingly to the predetermined boundaries of the sub-pixels of a display device of a touch display according to the Embodiments 4-1, 4-2 and 4-3 of the disclosure, respectively.

Arrangement and color compensation effect of the sets of column line segments in the Embodiment 4-1 (FIG. 14) are similar to that of the Embodiment 3-1 (FIG. 11), except for the sub-pixel arrangements and the lengths of each line segment corresponding to the numbers of sub-pixels. In the Embodiment 3-1, each set comprising four column line segments is related to a RGBW-stripe arrangement of the sub-pixels, and the length of each column line segment (ex: 61/62/63/64) corresponds to one sub-pixel side length (i.e. Lc1 substantially equal to 1×Lsub). In the Embodiment 4-1, each set comprising four column line segments is related to a RGBW-quadrant arrangement of the sub-pixels, and the length of each column line segment (ex: 71/72/73/74) corresponds to three times a length of the sub-pixel (i.e. Lc1 substantially equal to 3×Lsub). Also, the nearest column line segments of each set corresponding to the different rows of the sub-pixels, such as column line segments 71 and 72, or column line segments 73 and 74, are staggered in one sub-pixel along the row direction (i.e. X-direction) of the sub-pixels. Also, the nearest column line segments of each set corresponding to the same row of the sub-pixels, such as column line segments 71 and 73, or column line segments 72 and 74, are spaced apart by a distance corresponding to three sub-pixels along the row direction (i.e. X-direction).

In the Embodiment 4-1, the numbers of the same colored sub-pixels respectively adjacent to two opposite sides (ex: right and left sides) of the predetermined boundaries of the sub-pixels corresponding to four column line segments (71-74) of each set are identical. For example, three R sub-pixels, three G sub-pixels, three B sub-pixels and three W sub-pixels are respectively adjacent to the right sides (and also the left sides) of the predetermined boundaries of the sub-pixels corresponding to four column line segments (71-74) of each set (i.e. N1-1=N2-1=N3-1=N4-1=3, and N1-2=N2-2=N3-2=N4-2=3). The covering parts of the different colored sub-pixels can be compensated each other to achieve the color balance. Therefore, according to the Embodiment 4-1, the color unbalance can be successfully avoided when the viewer watches the left and right areas of the touch display (with RGBW-quadrant sub-pixels) from viewing angles along the horizontal off axes. Also, every row segment (coupled to the column line segments 71-74) of the metal mesh is aligned to R/G/B/W sub-pixel equally, and no color moiré issue occurs when the viewer watches the upper and lower areas of the touch display from viewing angles along the vertical off axes. Accordingly, no color moiré would be perceived in viewing the images displayed on the touch display of the Embodiment 4-1.

Arrangement and color compensation effect of the sets of row line segments in the Embodiment 4-2 (FIG. 15) are similar to that of the Embodiment 3-3 (FIG. 13), except for the sub-pixel arrangements. In the Embodiment 3-3, each set comprising four row line segments is related to a RGBW-stripe arrangement of the sub-pixels. In the Embodiment 4-2, each set comprising four row line segments (such as 75-78) is related to an arrangement of RGBW-quadrant sub-pixels. In the Embodiments 3-3 and 4-2, the length of each row line segment corresponds to three times a sub-pixel side width (i.e. Lr1 substantially equal to 3×Wsub). Also, the nearest row line segments of each set corresponding to the different columns of the sub-pixels, such as row line segments 75 and 77, or row line segments 76 and 78, are staggered in one sub-pixel along the column direction (i.e. Y-direction) of the sub-pixels. Also, the nearest row line segments of each set corresponding to the same column of the sub-pixels, such as row line segments 75 and 76, or row line segments 77 and 78, are spaced apart by a distance corresponding to three sub-pixels along the column direction (i.e. Y-direction).

In the Embodiment 4-2, the numbers of the same colored sub-pixels respectively adjacent to two opposite sides (ex: upper and lower sides) of the predetermined boundaries of the sub-pixels corresponding to four row line segments (75-78) of each set are identical. For example, three R sub-pixels, three G sub-pixels, three B sub-pixels and three W sub-pixels are respectively adjacent to the upper sides (and also the lower sides) of the predetermined boundaries of the sub-pixels corresponding to four row line segments (75-78) of each set (i.e. N1-1=N2-1=N3-1=N4-1=3, and N1-2=N2-2=N3-2=N4-2=3). The covering parts of the different colored sub-pixels can be compensated each other to achieve the color balance. Therefore, according to the Embodiment 4-2, the color unbalance can be successfully avoided when the viewer watches the upper and lower areas of the touch display from viewing angles along the vertical off axes. Also, every column segment (coupled to the row line segments 75-78) of the metal mesh is aligned to R/G/B/W sub-pixel equally, and no color moiré issue occurs when the viewer watches the right and left areas of the touch display from viewing angles along the horizontal off axes. Accordingly, no color moiré would be perceived in viewing the images displayed on the touch display of the Embodiment 4-2.

In the Embodiment 4-3 as shown in FIG. 16, each set of line segments comprises two column line segments 81 and 83, and two row line segments 82 and 84. Arrangement and color compensation effect of the sets of column line segments 81 and 83 in the Embodiment 4-3 (FIG. 16) are similar to that of the Embodiments 1-4 and 3-2. Arrangement and color compensation effect of the sets of row line segments 82 and 84 in the Embodiment 4-3 (FIG. 16) are similar to that of the Embodiment 3-3. Please refer to the related descriptions above, and the details are not redundantly repeated herein.

According to the aforementioned embodiments, the color unbalance can be greatly improved and even successfully avoided when the viewer watches the left, right, upper and lower areas of the display from different viewing angles, such as from the viewing angles along the horizontal off axes, or from the viewing angles along the vertical off axes. Thus, no color moiré can be perceived in viewing the images displayed on the touch display of the embodiments of the disclosure. Additionally, there are no particular limitations to the application types of sub-pixel arrays (ex: can be stripe type of sub-pixels, and quadrant type of sub-pixels, etc.) and colors (ex: can be RGB, and RGBW, etc.) of the display devices. Also, the disclosure can be applied to various types of electronic products having touch displays, such as smart phone, smart watch, tablet/notebook PC monitor, specific function display equipped with projected capacitance sensor, etc, and there is no particular limitation to the application types of the electronic products. Furthermore, the sensing units (such as metal mesh) of the touch displays of the embodiments can be fabricated by simple, quick and not expensive manufacturing procedures, which are suitable for the mass production.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch display, comprising:
a display device, comprising a plurality of sub-pixels, wherein the sub-pixels at least comprise first colored sub-pixels, second colored sub-pixels and third colored sub-pixels;
a touch layer, at least comprising a sensing unit and coupled to the display device, and the sensing unit exposing at least one boundary adjacent to one side of each of the sub-pixels, and the sensing unit comprising a plurality of sets of line segments, and each set of line segments at least comprising three line segments disposed correspondingly to predetermined boundaries of the sub-pixels,
wherein a total number of the first colored sub-pixels adjacent to same sides of the predetermined boundaries, a total number of the second colored sub-pixels adjacent to same sides of the predetermined boundaries, and a total number of the third colored sub-pixels adjacent to same sides of the predetermined boundaries are identical.

2. The touch display according to claim 1, wherein a total number of the first colored sub-pixels adjacent to two opposite sides of the predetermined boundaries, a total number of the second colored sub-pixels adjacent to two opposite sides of the predetermined boundaries, and a total number of the third colored sub-pixels adjacent to two opposite sides of the predetermined boundaries are identical.

3. The touch display according to claim 1, wherein the sub-pixels further comprise fourth colored sub-pixels, and a total number of the fourth colored sub-pixels and the total number of the first colored sub-pixels adjacent to the same sides of the predetermined boundaries of the sub-pixels are identical.

4. The touch display according to claim 3, wherein a total number of the fourth colored sub-pixels adjacent to first sides of the predetermined boundaries is identical to a total number of the fourth colored sub-pixels adjacent to second sides of the predetermined boundaries, wherein the second sides are opposite to the first sides.

5. The touch display according to claim 1, wherein the sub-pixels are arranged as a matrix in plural columns and rows, and the line segments of said sets corresponding adjacent rows of the sub-pixels are shifted by at least a distance corresponding to at least one of the sub-pixels.

6. The touch display according to claim 1, wherein the sets of line segments are column line segments parallel to a column direction of the sub-pixels, and the column line segments arranged correspondingly to same row of the sub-pixels are spaced apart by a distance corresponding to at least two of the sub-pixels.

7. The touch display according to claim 6, wherein the column line segments arranged correspondingly to same column of the sub-pixels are spaced apart by another distance corresponding to at least one of the sub-pixel.

8. The touch display according to claim 6, wherein a length of the column line segments (Lc1) is equal to a sub-pixel side length (Lsub).

9. The touch display according to claim 8, wherein two of said column line segments of each set disposed correspondingly to the adjacent rows of the sub-pixels are shifted by at least a distance of a sub-pixel side width (Wsub).

10. The touch display according to claim 1, wherein the sets of line segments are row line segments parallel to a row direction of the sub-pixels, and the row line segments arranged correspondingly to same column of the sub-pixels are spaced apart by a distance corresponding to at least two of the sub-pixels.

11. The touch display according to claim 10, wherein the row line segments arranged correspondingly to same row of the sub-pixels are spaced apart by another distance corresponding to at least two of the sub-pixels.

12. The touch display according to claim 10, wherein a length of the row line segments (Lr1) is at least substantially equal to or larger than two times a sub-pixel side width (Wsub).

13. The touch display according to claim 12, wherein two of said row line segments of each set disposed correspondingly to the adjacent column of the sub-pixels are shifted by at least a distance of a sub-pixel side length (Lsub).

14. The touch display according to claim 1, wherein the sub-pixels comprise four different colored sub-pixels arranged as a quadrant arrangement, and the line segments are column line segments parallel to a column direction of the sub-pixels.

15. The touch display according to claim 14, wherein the nearest column line segments of each set corresponding to different rows of the sub-pixels are staggered in at least one sub-pixel along a row direction of the sub-pixels, and the nearest column line segments of each set corresponding to same row of the sub-pixels are spaced apart by a distance corresponding to at least three of the sub-pixels along the row direction. (FIG. 14)

16. The touch display according to claim 14, wherein the column line segments of each set are at least substantially equal to three times a sub-pixel side length (3×Lsub).

17. The touch display according to claim 1, wherein the sub-pixels comprise four different colored sub-pixels arranged as a quadrant arrangement, and the line segments are row line segments parallel to a row direction of the sub-pixels.

18. The touch display according to claim 17, wherein the nearest row line segments of each set corresponding to different columns of the sub-pixels are staggered in one sub-pixel along a column direction of the sub-pixels, and the nearest row line segments of each set corresponding to same column of the sub-pixels are spaced apart by a distance corresponding to three of the sub-pixels along the column direction.

19. The touch display according to claim 18, wherein each of the row line segments is equal to three times a sub-pixel side width (3×Wsub).

20. The touch display according to claim 1, wherein the sensing unit is a mesh having conducting lines woven together and coupled to each other, and the conducting lines comprises the sets of line segments.
